(19) United States
(12) Patent Application Publication
(10) Pub. No.: US 2025/0277585 A1
(43) Pub. Date: Sep. 4, 2025

(54) COMBUSTOR SIZE RATING FOR A GAS TURBINE ENGINE USING HYDROGEN FUEL

(71) Applicant: General Electric Company, Schenectady, NY (US)

(72) Inventors: Michael A. Benjamin, Cincinnati, OH (US); Manampathy G. Giridharan, Mason, OH (US)

(21) Appl. No.: 18/660,525

(22) Filed: May 10, 2024

Related U.S. Application Data
(63) Continuation-in-part of application No. 17/457,559, filed on Dec. 3, 2021, now Pat. No. 12,078,100.

(51) Int. Cl. F23R 3/28

(52) U.S. Cl. CPC F23R 3/283; F23R 2900/00002

(57) ABSTRACT

A gas turbine engine includes a hydrogen fuel delivery assembly configured to deliver a hydrogen fuel flow, a compressor section configured to compress air flowing therethrough to provide a compressed air flow, and a combustor including a combustion chamber having a burner length and a burner dome height. The combustion chamber is configured to combust a mixture of the hydrogen fuel flow and the compressed air flow. The combustion chamber can be characterized by a combustor size rating between one inch and seven inches. In more detail, the combustion chamber can be characterized by the combustor size rating between one inch and seven inches at a core air flow parameter between two and one half kN and sixty kN, in which the combustor size rating is a function of the core air flow parameter.

### CROSS-REFERENCE TO RELATED APPLICATION(S)

This application is a continuation-in-part of U.S. application Ser. No. 17/457,559, filed Dec. 3, 2021, now allowed, which is incorporated herein by reference in its entirety.

### TECHNICAL FIELD

The present disclosure relates to a combustor for a gas turbine engine using hydrogen fuel, and in particular, for a gas turbine engine for aircraft.

### BACKGROUND

The propulsion system for commercial aircraft typically includes one or more aircraft engines, such as turbofan jet engines. The aircraft engine(s) may be mounted to a respective one of the wings of the aircraft, such as in a suspended position beneath the wing using a pylon. These engines may be powered by aviation turbine fuel, which is typically a combustible hydrocarbon liquid fuel, such as a kerosene-type fuel, having a desired carbon number and carbon to hydrogen ratio. Such fuel produces carbon dioxide emissions upon combustion and improvements to reduce such carbon dioxide emissions in commercial aircraft are desired.

### BRIEF DESCRIPTION OF THE DRAWINGS

Features and advantages of the present disclosure will be apparent from the following, more particular, description of various exemplary embodiments, as illustrated in the accompanying drawings, wherein like reference numbers generally indicate identical, functionally similar, and/or structurally similar elements.

FIG. 1 is a schematic perspective view of an aircraft having a gas turbine engine according to an embodiment of the present disclosure.

FIG. 2 is a schematic, cross-sectional view, taken along line 2-2 in FIG. 1, of the gas turbine engine of the aircraft shown in FIG. 1.

FIG. 3 is a perspective view of an unducted single fan engine that may be used with the aircraft shown in FIG. 1.

FIG. 4 is a schematic, cross-sectional view, taken along line 4-4 in FIG. 3, of the unducted single fan engine shown in FIG. 3.

FIG. 5 is a schematic, cross-sectional view, taken along line 2-2 in FIG. 1, of a turbojet engine that may be used with the aircraft shown in FIG. 1.

FIG. 6 is cross-sectional view of a first combustor for the gas turbine engine shown in FIG. 2, showing detail 6 of FIG. 2.

FIG. 7 is cross-sectional view of a second combustor for the gas turbine engine shown in FIG. 2, showing detail 6 of FIG. 2.

FIG. 8 is cross-sectional view of a third combustor for the gas turbine engine shown in FIG. 2, showing detail 6 of FIG. 2.

FIG. 9 is cross-sectional view of a fourth combustor for the gas turbine engine shown in FIG. 2, showing detail 6 of FIG. 2.

FIG. 10 is cross-sectional view of a fifth combustor for the gas turbine engine shown in FIG. 2, showing detail 6 of FIG. 2.

FIG. 11 is a graph illustrating combustor length (squared) as a function of combustor height, according to embodiments of the present disclosure.

FIG. 12 is a graph illustrating combustor size rating as a function of core air flow parameter in engine gas turbine engines using hydrogen fuel, according to embodiments of the present disclosure.

FIG. 13 depicts a combustion section of a gas turbine engine.

FIG. 14 is a schematic of a side cross-sectional view taken along line XIV of FIG. 13 of a combustor in the combustion section formed from a combustor liner having multiple sets of dilution passages according to an aspect of the disclosure herein.

FIG. 15 is a schematic, transverse cross-sectional view of a first dilution passage arrangement provided on a dome wall suitable for use within the combustor of FIG. 14.

FIG. 16 is a partial side cross-sectional view of a portion of the first dilution passage arrangement of FIG. 15 as seen from line XVI of FIG. 15, illustrating a first passage angle defining a first orientation for the dilution passage.

FIG. 17 is a partial side cross-sectional view of a portion of the first dilution passage arrangement as seen from line XVII of FIG. 15, illustrating the first passage angle defining a second orientation for the dilution passage.

FIG. 18 is a partial side cross-sectional view of a portion of the first dilution passage arrangement of FIG. 15 as seen from line XVIII of FIG. 15, illustrating the first passage angle defining a third orientation for the dilution passage.

FIG. 19 is an enlarged, schematic, front view of the dome wall as seen from section XIX of FIG. 15, the dilution passage including a second passage angle.

FIG. 20 is a schematic, front view of the dome wall including the dilution passage arrangement of FIG. 15, further illustrating a flame shaping attributable to the dilution passages.

FIG. 21 is a schematic, transverse view of a second dilution passage arrangement suitable for use as the dilution passage arrangement of FIG. 15, the dilution passage arrangement including a plurality of slots that follow a spiral pattern.

FIG. 22 is a schematic, transverse view of a third dilution passage arrangement suitable for use as the dilution passage arrangement of FIG. 15, the dilution passage arrangement including a first subset of slots following a curved line and a second subset of slots following a linear line.

FIG. 23 is a schematic, transverse view of a fourth dilution passage arrangement suitable for use as the dilution passage arrangement of FIG. 15, the dilution passage arrangement including a first subset of slots following a curved line and a second subset of slots following a linear line that is extends non-circumferentially about the dome wall.

FIG. 24 is a schematic, transverse view of a fifth dilution passage arrangement suitable for use as the dilution passage arrangement of FIG. 15, the dilution passage arrangement including a plurality of slots following a non-circular polygonal path.

FIG. 25 is a schematic, transverse view of a sixth dilution passage arrangement suitable for use as the dilution passage arrangement of FIG. 15, the dilution passage arrangement including a plurality of slots with a non-symmetrical formation.

FIG. 26 is a schematic, transverse view of a seventh dilution passage arrangement suitable for use as the dilution passage arrangement of FIG. 15, the dilution passage arrangement including a plurality of slots having differing cross-sectional areas.

FIG. 27 is a schematic, transverse view of an eighth dilution passage arrangement suitable for use as the dilution passage arrangement of FIG. 15, the dilution passage arrangement including a plurality of slots having a first row of slots and a second row of slots.

### DETAILED DESCRIPTION

Features, advantages, and embodiments of the present disclosure are set forth or apparent from a consideration of the following detailed description, drawings, and claims. Moreover, it is to be understood that the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values and/or endpoints defining range(s) of values.

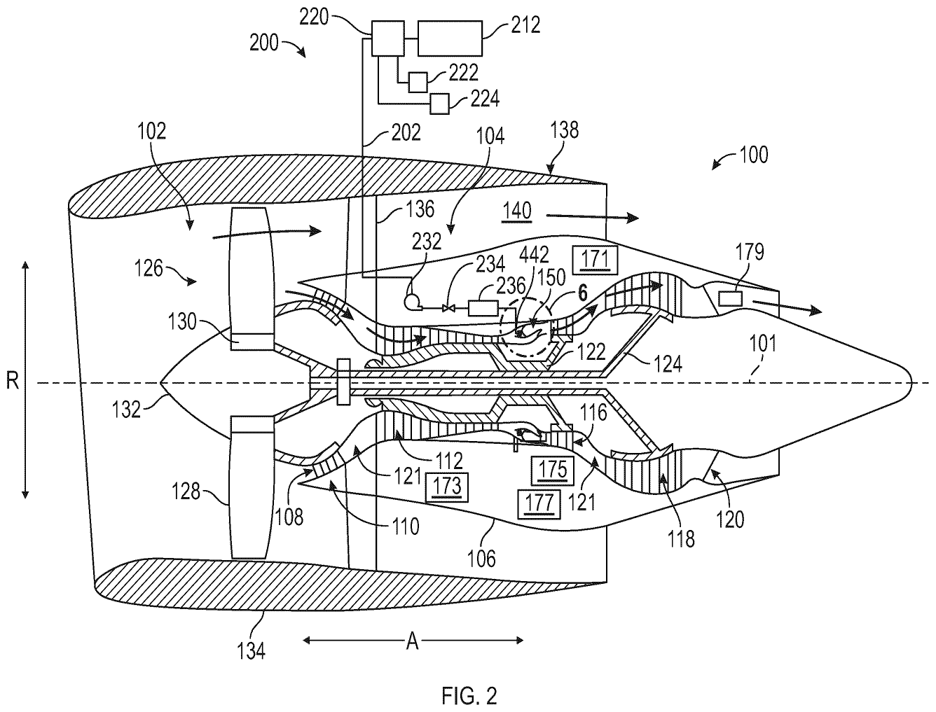

The term “bypass ratio,” unless stated otherwise, means the bypass ratio at take off conditions. The term bypass ratio as used herein means the ratio between the mass flow rate of air flow accelerated by the engine that bypasses the engine core to the mass flow rate of the air flow entering the engine core. For example, in an exemplary engine such as the turbofan engine 100 depicted in FIG. 2 and discussed further below, the bypass ratio is the ratio of the mass flow rate of the air flow entering the bypass air flow passage 140 to the mass flow rate of the air flow entering the core air flow path 121. The bypass ratio can also be estimated as a ratio of the area of an inlet to the bypass duct (e.g., inlet of the bypass air flow passage 140, discussed below) or an area swept by a rotor (e.g., the area swept by fan blades 322, discussed below) to the area of the inlet to the engine core (e.g., inlet of the core air flow path 121).

The term “thrust,” unless stated otherwise, means the maximum thrust at take off. This meaning of thrust is adopted when computing a core airflow parameter (relationship (2), below).

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Combustible hydrocarbon liquid fuel, such as Jet-A fuel, has long been used in gas turbine engines and the components of gas turbine engines, particularly, the combustor, have been designed for such fuels. A hydrogen fuel may be utilized to eliminate carbon dioxide emissions from commercial aircraft. Hydrogen fuel, however, poses a number of challenges as compared to combustible hydrocarbon liquid fuel, such as Jet-A fuel. Hydrogen fuel, for example, is a highly reactive fuel that burns at higher temperatures than combustible hydrocarbon liquid fuel. Hydrogen fuel also has much higher flame speeds. For example, the laminar flame speed for a hydrogen fuel of diatomic hydrogen is an order of magnitude greater than the laminar flame speed for Jet-A fuel.

When testing hydrogen fuel in current gas turbine engines with rich burn combustors, we, the inventors, observed that the higher combustion temperature of hydrogen fuel results in increased production of nitrogen oxides (“NOx”), as compared to combustible hydrocarbon liquid fuel. We also observed in our testing that NOx emissions are sensitive to combustor residence time. As noted above, hydrogen fuel is highly reactive (relative to other fuels) with a wide range of flammability limits and very high flame speeds, resulting in a very short hydrogen flame close to the front end of the combustor. With such a short flame, the post-flame residence time increases for combustors designed for Jet-A fuel. These findings resulted in a realization that when designing a hydrogen fuel combustor to meet NOx emission targets, the combustor residence time needs to be reduced by more than about fifty percent. To find a suitable combustor design for gas turbine engines using hydrogen fuel, we conceived of a wide variety of combustors having different shapes and sizes in order to determine which embodiment(s) were most promising for a variety of contemplated engine designs and thrust classes. The various embodiments, as described herein and as shown in the figures, are combustors that are sized to meet NOx emissions targets.

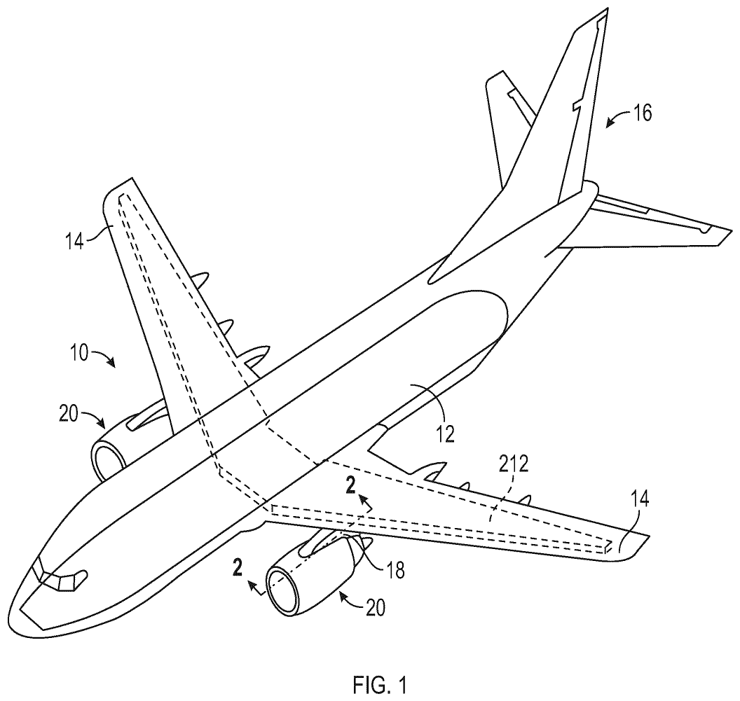

FIG. 1 is a perspective view of an aircraft 10 that may implement various preferred embodiments. The aircraft 10 includes a fuselage 12, wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 1 includes a pair of engines 20. In this embodiment, each engine 20 is attached to one of the wings 14 by a pylon 18 in an under-wing configuration. Although the engines 20 are shown attached to the wing 14 in an under-wing configuration in FIG. 1, in other embodiments, the engine 20 may have alternative configurations and be coupled to other portions of the aircraft 10. For example, the engine 20 may additionally or alternatively include one or more aspects coupled to other parts of the aircraft 10, such as, for example, the empennage 16 and the fuselage 12.

As will be described further below with reference to FIG. 2, the engines 20 shown in FIG. 1 are gas turbine engines that are each capable of selectively generating a propulsive thrust for the aircraft 10. The amount of propulsive thrust may be controlled at least in part based on a volume of fuel provided to the gas turbine engines 20 via a fuel system 200. The fuel is stored in a fuel tank 212 of the fuel system 200. As shown in FIG. 1, at least a portion of the fuel tank 212 is located in each wing 14 and a portion of the fuel tank 212 is located in the fuselage 12 between the wings 14. The fuel tank 212, however, may be located at other suitable locations in the fuselage 12 or the wing 14. The fuel tank 212 may also be located entirely within the fuselage 12 or the wing 14. The fuel tank 212 may also be separate tanks instead of a single, unitary body, such as, for example, two tanks each located within a corresponding wing 14.

Although the aircraft 10 shown in FIG. 1 is an airplane, the embodiments described herein may also be applicable to other aircraft 10, including, for example, helicopters and unmanned aerial vehicles (UAV). The aircraft discussed herein are fixed-wing aircraft or rotor aircraft that generate lift by aerodynamic forces acting on, for example, a fixed wing (e.g., wing 14) or a rotary wing (e.g., rotor of a helicopter), and are heavier-than-air aircraft, as opposed to lighter-than-air aircraft (such as a dirigible). The engine 20 may be used in various other applications including stationary power generation systems and other vehicles beyond the aircraft 10 explicitly described herein, such as boats, ships, cars, trucks, and the like.

FIG. 2 is a schematic, cross-sectional view of one of the engines 20 used in the propulsion system for the aircraft 10 shown in FIG. 1. The cross-sectional view of FIG. 2 is taken along line 2-2 in FIG. 1. For the embodiment depicted in FIG. 2, the engine 20 is a high bypass turbofan engine that is referred to as a turbofan engine 100 herein. The turbofan engine 100 has an axial direction A (extending parallel to a longitudinal centerline axis 101, shown for reference in FIG. 2), a radial direction R, and a circumferential direction. The circumferential direction (not depicted in FIG. 2) extends in a direction rotating about the axial direction A. The turbofan engine 100 includes a fan section 102 and a turbomachine 104 disposed downstream from the fan section 102.

The turbomachine 104 depicted in FIG. 2 includes a tubular outer housing or nacelle 106 and an inlet 108. Within the housing 106 there is an engine core, which includes, in a serial flow relationship, a compressor section including a booster or low-pressure (LP) compressor 110 and a high-pressure (HP) compressor 112, a combustion section 150 (also referred to herein as a combustor 150), a turbine section including a high-pressure (HP) turbine 116 and a low-pressure (LP) turbine 118, and a jet exhaust nozzle section 120. The compressor section, the combustor 150, and the turbine section together define at least in part a core air flow path 121 extending from the inlet 108 to the jet exhaust nozzle section 120. The turbofan engine 100 further includes one or more drive shafts. More specifically, the turbofan engine includes a high-pressure (HP) shaft or spool 122 drivingly connecting the HP turbine 116 to the HP compressor 112, and a low-pressure (LP) shaft or spool 124 drivingly connecting the LP turbine 118 to the LP compressor 110.

The fan section 102 shown in FIG. 2 includes a fan 126 having a plurality of fan blades 128 coupled to a disk 130. The fan blades 128 and the disk 130 are rotatable, together, about the longitudinal centerline axis 101 by the LP shaft 124. The booster 108 may also be directly driven by the LP shaft 124, as depicted in FIG. 2. The disk 130 is covered by a rotatable front hub 132 aerodynamically contoured to promote an air flow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially spaced outlet guide vanes 136. A downstream section 138 of the nacelle 134 extends over an outer portion of the turbomachine 104 so as to define a bypass air flow passage 140 therebetween.

The turbofan engine 100 is operable with the fuel system 200 and receives a flow of fuel from the fuel system 200. As will be described further below, the fuel system 200 includes a fuel delivery assembly 202 providing the fuel flow from the fuel tank 212 to the turbofan engine 100, and, more specifically, to a plurality of fuel nozzles 442 that inject fuel into a combustion chamber 430 of the combustor 150.

The turbofan engine 100 also includes various accessory systems to aid in the operation of the turbofan engine 100 and/or an aircraft including the turbofan engine 100. For example, the turbofan engine 100 may include a main lubrication system 171, a compressor cooling air (CCA) system 173, an active thermal clearance control (ATCC) system 175, and a generator lubrication system 177, each of which is depicted schematically in FIG. 2. The main lubrication system 171 is configured to provide a lubricant to, for example, various bearings and gear meshes in the compressor section, the turbine section, the HP spool 122, and the LP shaft 124. The lubricant provided by the main lubrication system 171 may increase the useful life of such components and may remove a certain amount of heat from such components through the use of one or more heat exchangers. The compressor cooling air (CCA) system 173 provides air from one or both of the HP compressor 112 or LP compressor 110 to one or both of the HP turbine 116 or LP turbine 118. The active thermal clearance control (ATCC) system 175 acts to minimize a clearance between tips of turbine blades and casing walls as casing temperatures vary during a flight mission. The generator lubrication system 177 provides lubrication to an electronic generator (not shown), as well as cooling/heat removal for the electronic generator. The electronic generator may provide electrical power to, for example, a startup electrical motor for the turbofan engine 100 and/or various other electronic components of the turbofan engine 100 and/or an aircraft including the turbofan engine 100.

Heat from these accessory systems 171, 173, 175, and 177, and other accessory systems, may be provided to various heat sinks as waste heat from the turbofan engine 100 during operation, such as to various vaporizers 220, as discussed below. Additionally, the turbofan engine 100 may include one or more heat exchangers 179 within, for example, the turbine section or jet exhaust nozzle section 120 for extracting waste heat from an air flow therethrough to also provide heat to various heat sinks, such as the vaporizers 220, discussed below.

The fuel system 200 of this embodiment is configured to store the fuel for the turbofan engine 100 in the fuel tank 212 and to deliver the fuel to the turbofan engine 100 via the fuel delivery assembly 202. The fuel delivery assembly 202 includes tubes, pipes, and the like, to fluidly connect the various components of the fuel system 200 to the turbofan engine 100. As discussed above, the turbofan engine 100, and, in particular, the combustor 150 discussed herein may be particularly suited for use with hydrogen fuel (diatomic hydrogen). In the embodiments shown in FIG. 2, the fuel is a hydrogen fuel comprising hydrogen, more specifically, diatomic hydrogen. In some embodiments, the hydrogen fuel may consist essentially of hydrogen.

The fuel tank 212 may be configured to hold the hydrogen fuel at least partially in the liquid phase and may be configured to provide hydrogen fuel to the fuel delivery assembly 202 substantially completely in the liquid phase, such as completely in the liquid phase. For example, the fuel tank 212 may have a fixed volume and contain a volume of the hydrogen fuel in the liquid phase (liquid hydrogen fuel). As the fuel tank 212 provides hydrogen fuel to the fuel delivery assembly 202 substantially completely in the liquid phase, the volume of the liquid hydrogen fuel in the fuel tank 212 decreases and the remaining volume in the fuel tank 212 is made up by, for example, hydrogen in the gaseous phase (gaseous hydrogen). As used herein, the term “substantially completely” as used to describe a phase of the hydrogen fuel, refers to at least 99% by mass of the described portion of the hydrogen fuel being in the stated phase, such as at least 97.5%, such as at least 95%, such as at least 92.5%, such as at least 90%, such as at least 85%, or such as at least 75% by mass of the described portion of the hydrogen fuel being in the stated phase.

To store the hydrogen fuel substantially completely in the liquid phase, the hydrogen fuel is stored in the fuel tank 212 at very low (cryogenic) temperatures. For example, the hydrogen fuel may be stored in the fuel tank 212 at about −253 degrees Celsius or less at atmospheric pressure, or at other temperatures and pressures to maintain the hydrogen fuel substantially in the liquid phase. The fuel tank 212 may be made from known materials such as titanium, Inconel®, aluminum, or composite materials. The fuel tank 212 and the fuel system 200 may include a variety of supporting structures and components to facilitate storing the hydrogen fuel in such a manner.

The liquid hydrogen fuel is supplied from the fuel tank 212 to the fuel delivery assembly 202. The fuel delivery assembly 202 may include one or more lines, conduits, etc., configured to carry the hydrogen fuel between the fuel tank 212 and the turbofan engine 100. The fuel delivery assembly 202 thus provides a flow path of the hydrogen fuel from the fuel tank 212 to the turbofan engine 100. The hydrogen fuel is delivered to the engine by the fuel delivery assembly 202 in the gaseous phase, the supercritical phase, or both (e.g., the gaseous phase and the supercritical phase). The fuel system 200 thus includes a vaporizer 220 in fluid communication with the fuel delivery assembly 202 to heat the liquid hydrogen fuel flowing through the fuel delivery assembly 202. The vaporizer 220 is positioned in the flow path of the hydrogen fuel between the fuel tank 212 and the turbofan engine 100. The vaporizer 220 may be positioned at least partially within the fuselage 12 or the wing 14 (both shown in FIG. 1), such as at least partially within the wing 14. The vaporizer 220 may, however, be positioned at other suitable locations in the flow path of the hydrogen between the fuel tank 212 and the turbofan engine 100. For example, the vaporizer 220 may be positioned external to the fuselage 12 and the wing 14 (both shown in FIG. 1) and positioned at least partially within the pylon 18 (FIG. 1) or the turbofan engine 100 (FIG. 2). When positioned in the turbofan engine 100, the vaporizer may be located in the nacelle 134, for example. Although only one vaporizer 220 is shown in FIG. 2, the fuel system 200 may include multiple vaporizers 220. For example, when a vaporizer 220 is positioned in the turbofan engine 100 or in the pylon 18 and functions as a primary vaporizer configured to operate once the turbofan engine 100 is in a thermally stable condition, another vaporizer 220 is positioned upstream of the primary vaporizer and proximate to the fuel tank 212, and functions as a primer vaporizer during start-up (or prior to start-up) of the turbofan engine 100.

The vaporizer 220 is in thermal communication with at least one heat source 222, 224. In this embodiment, the vaporizer 220 is in thermal communication with a primary heat source 222 and an auxiliary heat source 224. In this embodiment, primary heat source 222 is waste heat from the turbofan engine 100, and the vaporizer 220 is, thus, thermally connected to at least one of the main lubrication system 171, the compressor cooling air (CCA) system 173, the active thermal clearance control (ATCC) system 175, the generator lubrication system 177, and the heat exchangers 179 to extract waste heat from the turbofan engine 100 to heat the hydrogen fuel. In such a manner, the vaporizer 220 is configured to operate by drawing heat from the primary heat source 222 once the turbofan engine 100 is capable of providing enough heat, via the auxiliary heat source 224, to the vaporizer 220, in order to facilitate operation of the vaporizer 220.

The vaporizer 220 may be heated by any suitable heat source, and, in this embodiment, for example, the auxiliary heat source 224 is a heat source external to the turbofan engine 100. The auxiliary heat source 224 may include, for example, an electrical power source, a catalytic heater or burner, and/or a bleed air flow from an auxiliary power unit. The auxiliary heat source 224 may be integral to the vaporizer 220, such as when the vaporizer 220 includes one or more electrical resistance heaters, or the like, that are powered by the electrical power source. In this configuration the auxiliary heat source 224 may provide heat for the vaporizer 220 independent of whether or not the turbofan engine 100 is running and can be used, for example, during start-up (or prior to start-up) of the turbofan engine 100.

As noted, the vaporizer 220 is in communication with the flow of the hydrogen fuel through the fuel delivery assembly 202. The vaporizer 220 is configured to draw heat from at least one of the primary heat source 222 and the auxiliary heat source 224 to heat the flow of hydrogen fuel from a substantially completely liquid phase to a substantially completely gaseous phase or to a substantially completely supercritical phase.

The fuel system 200 also includes a high-pressure pump 232 in fluid communication with the fuel delivery assembly 202 to induce the flow of the hydrogen fuel through the fuel delivery assembly 202 to the turbofan engine 100. The high-pressure pump 232 may generally be the primary source of pressure rise in the fuel delivery assembly 202 between the fuel tank 212 and the turbofan engine 100. The high-pressure pump 232 may be configured to increase a pressure in the fuel delivery assembly 202 to a pressure greater than a pressure within the combustion chamber 430 of the combustor 150 of the turbofan engine 100, and to overcome any pressure drop of the components placed downstream of the high-pressure pump 232.

The high-pressure pump 232 is positioned within the flow of hydrogen fuel in the fuel delivery assembly 202 at a location downstream of the vaporizer 220. In this embodiment, the high-pressure pump 232 is positioned external to the fuselage 12 and the wing 14, and is positioned at least partially within the pylon 18, or at least partially within the turbofan engine 100. More specifically, the high-pressure pump 232 is positioned within the turbofan engine 100. With the high-pressure pump 232 located in such a position, the high-pressure pump 232 may be any suitable pump configured to receive the flow of hydrogen fuel in substantially completely a gaseous phase or a supercritical phase. In other embodiments, however, the high-pressure pump 232 may be positioned at other suitable locations, including other positions within the flow path of the hydrogen fuel. For example, the high-pressure pump 232 may be located upstream of the vaporizer 220 and may be configured to receive the flow of hydrogen fuel through the fuel delivery assembly 202 in a substantially completely liquid phase.

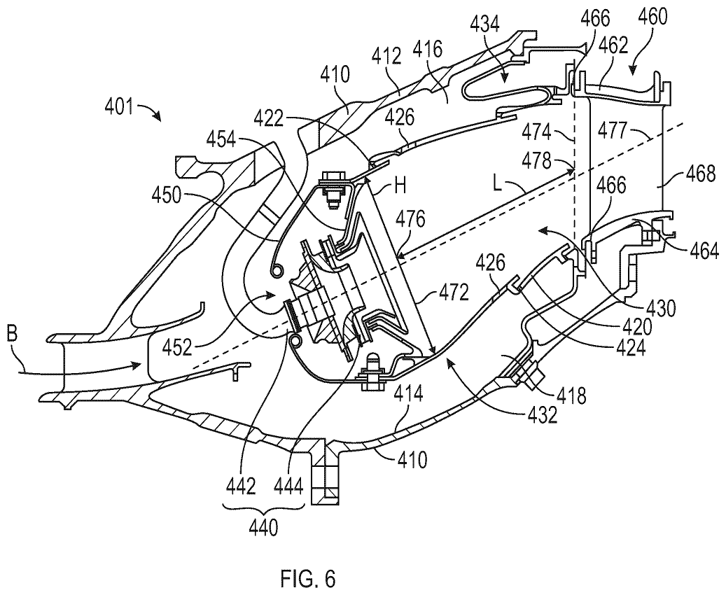

The fuel system 200 also includes a metering unit in fluid communication with the fuel delivery assembly 202. Any suitable metering unit may be used including, for example, a fuel metering valve 234 placed in fluid communication with the fuel delivery assembly 202. The fuel delivery assembly 202 is configured to provide the fuel metering valve 234, and the fuel metering valve 234 is configured to receive hydrogen fuel. In this embodiment, the fuel metering valve 234 is positioned downstream of the high-pressure pump 232. The fuel metering valve 234 is further configured to provide the flow of the hydrogen fuel to the turbofan engine 100 in a desired manner. The fuel metering valve 234 is configured to provide a desired volume of the fuel at, for example, a desired flow rate, to a fuel manifold 236 of the turbofan engine 100. The fuel manifold 236 then distributes (provides) the hydrogen fuel received to a plurality of fuel nozzles 442 (see FIG. 6) within the combustion section 150 of the turbofan engine 100 where the hydrogen fuel is mixed with compressed air, and the mixture of hydrogen fuel and compressed air is combusted to generate combustion gases that drive the turbofan engine 100. Adjusting the fuel metering valve 234 changes the volume of fuel provided to the combustion chamber 430 (see FIG. 6) of the combustor 150 and, thus, changes the amount of propulsive thrust produced by the turbofan engine 100 to propel the aircraft 10.

Although the turbofan engine 100 is shown as a direct drive, fixed-pitch turbofan engine 100, in other embodiments, a gas turbine engine may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Additionally, in still other exemplary embodiments, the exemplary turbofan engine 100 may include or be operably connected to any other suitable accessory systems. Additionally, or alternatively, the exemplary turbofan engine 100 may not include or be operably connected to one or more of the accessory systems 171, 173, 175, and 177, discussed above.

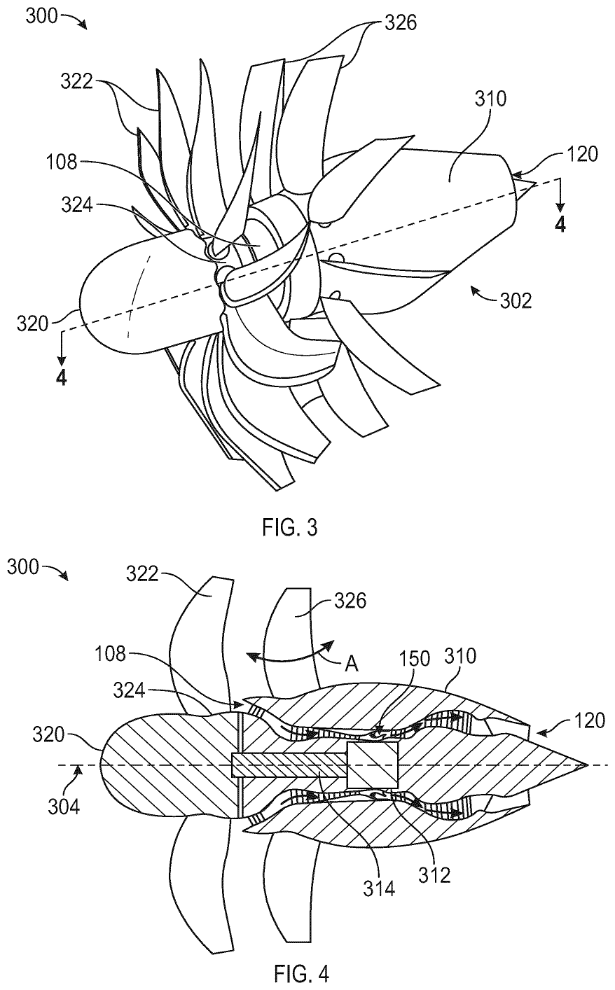

The turbofan engine 100 discussed herein is an example of the engine 20 in which the combustors 150 discussed herein may be used. In other embodiments, other suitable engines may be utilized with aspects of the present disclosure. For example, FIGS. 3 and 4 show an unducted single fan (USF) engine 300 that may be used as the engine 20 of the aircraft 10 and implement the fuel system described above, and combustor designs discussed further below. FIG. 3 is a perspective view of the USF engine 300 and FIG. 4 is a cross-sectional view taken along a line 4-4 in FIG. 3.

The USF engine 300 includes a housing 302. The housing 302 may be formed of a nacelle 310 and spinner 320. The nacelle 310 and/or the spinner 320 house internal components of the USF engine 300. For example, the nacelle 310 houses a torque producing system 312 coupled to a shaft 314. The torque producing system 312 in the embodiments discussed herein is a gas turbine engine, such as the turbomachine 104 discussed above with reference to FIG. 2 and, thus, the nacelle 310 of this embodiment is similar to the tubular outer housing 106 discussed above. As the turbomachine 104 used as the torque producing system 312 of the USF engine has the same or similar components and features as the turbomachine 104 discussed above, a detailed description of the components of the turbomachine 104 used in of the USF engine 300 is omitted.

The torque producing system 312 and the shaft 314 are configured to operate (e.g., to rotate) the spinner 320. One or more fan blades 322 are coupled to the spinner 320. More specifically, the spinner 320 includes a fan hub 324, and the fan blades 322 are coupled to the fan hub 324. The spinner 320 rotates with respect to the nacelle 310. Coupled to the nacelle 310 may be one or more outlet guide vanes 326. In this embodiment, the outlet guide vanes 326 are positioned aft of the fan blades 322. During operation, the one or more fan blades 322 (by virtue of the connection to the spinner 320) rotate circumferentially around a longitudinal centerline 304, in this embodiment, and the nacelle 310 is stationary such that the one or more outlet guide vanes 326 do not rotate around the longitudinal centerline 304 and are, thus, stationary with respect to rotation about the longitudinal centerline 304. Although the outlet guide vanes 326 are stationary with respect to the longitudinal centerline 304, the outlet guide vanes 326 are capable of being rotated or moved with respect to the nacelle 310, for example, in the direction A of FIG. 4.

During operation of the USF engine 300, air flows from the left side of FIG. 4 toward the right side of FIG. 4. A portion of the air flow may flow past the fan blades 322 and the outlet guide vanes 326. A portion of the air flow may enter the nacelle 310 through the annular inlet 108 to be mixed with the hydrogen fuel for combustion in a combustor 150 of the USF engine 300 and exit through an outlet 120. The outlet guide vanes 326 may be movable with respect to the nacelle 310 to guide the air flow in a particular direction. Each outlet guide vane 326 may be movable to adjust the lean, pitch, sweep, or any combination thereof, of the outlet guide vane 326.

In the embodiment shown in FIGS. 3 and 4, a forward end or front portion of the housing 302 includes the one or more fan blades 322 and the one or more outlet guide vanes 326. In other embodiments, the one or more fan blades 322 and the one or more outlet guide vanes 326 may have a different arrangement with respect to the housing 302. For example, the one or more fan blades 322 and the one or more outlet guide vanes 326 may be located on an aft end or rear portion of the housing 302, such as coupled to a rear portion of the housing 302.

In other embodiments, an engine according to the disclosure may be configured to have either the stationary vanes positioned forward of the rotating blades 322 (thus, the blades 326 are inlet guide vanes) or both the blades 326 and blades 322 configured to operate in a counter-rotating fashion. Either “pusher” or “puller” configurations are contemplated. In each of these alternative embodiments, the fuel delivery system 200 and combustor 150, as described in great detail below, may be used. An example of a suitable engine configuration for a counter-rotating engine is shown and described in FIG. 1 and col. 3, line 43 through col. 4, line 11 of U.S. Pat. No. 10,800,512, hereby incorporated by reference for all purposes. Alternative embodiments of the USF engine 300 are shown and described in FIGS. 6, 7, and 8 and col. 4, line 51 through col. 5, line 19 of U.S. Pat. No. 10,704,410, hereby incorporated by reference for all purposes.

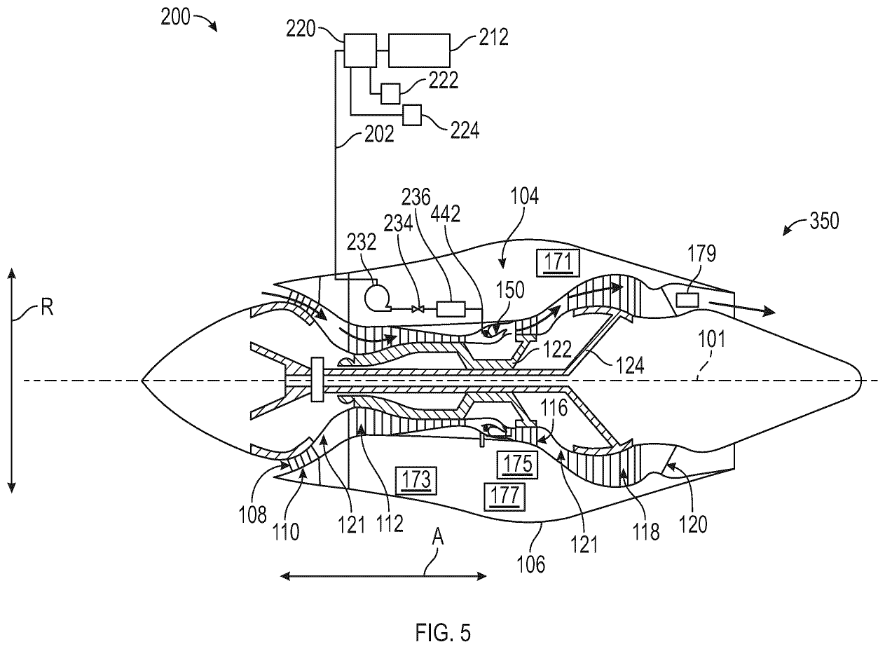

In further embodiments, a turbojet engine 350 may be used as the engine 20. FIG. 5 is a schematic, cross-sectional view of the turbojet engine 350. The cross-sectional view of FIG. 5 is similar to FIG. 2, which is taken along line 2-2 in FIG. 1. The turbojet engine 350 includes the same or similar components of the turbomachine 104 of the turbofan engine 100 and a detailed description of these components is omitted. An exemplary turbojet engine 350 may not include a fan with bypass duct. An exemplary turbojet engine 350 may have high velocity exhaust from the engine, which produces a majority of the thrust for the turbojet engine 350. In still further embodiments, other suitable gas turbine engines, such as a turboshaft engine, a turboprop engine, and the like, may be utilized with aspects of the present disclosure.

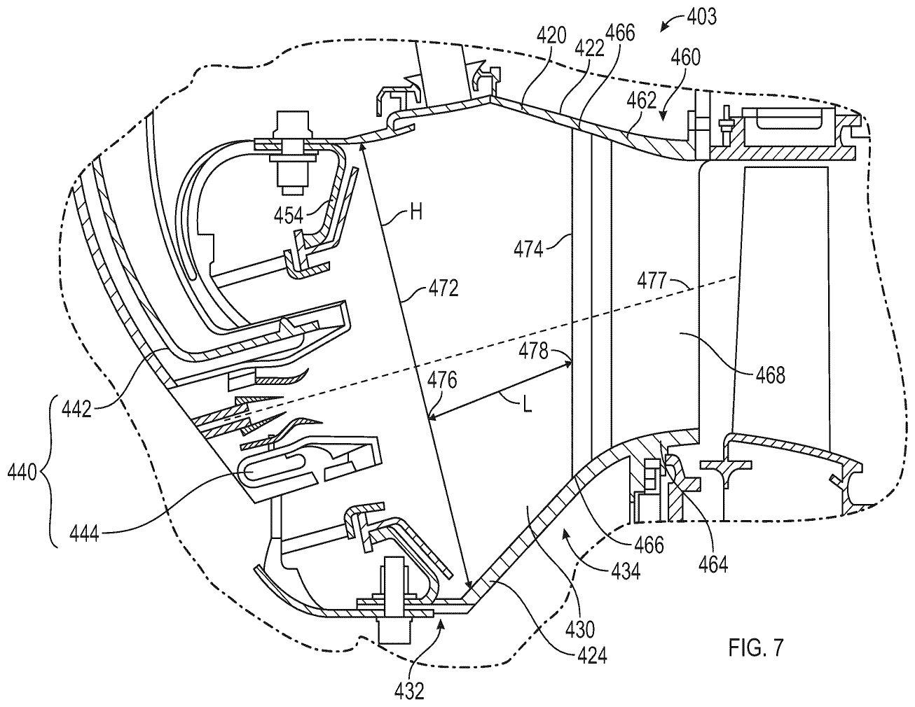

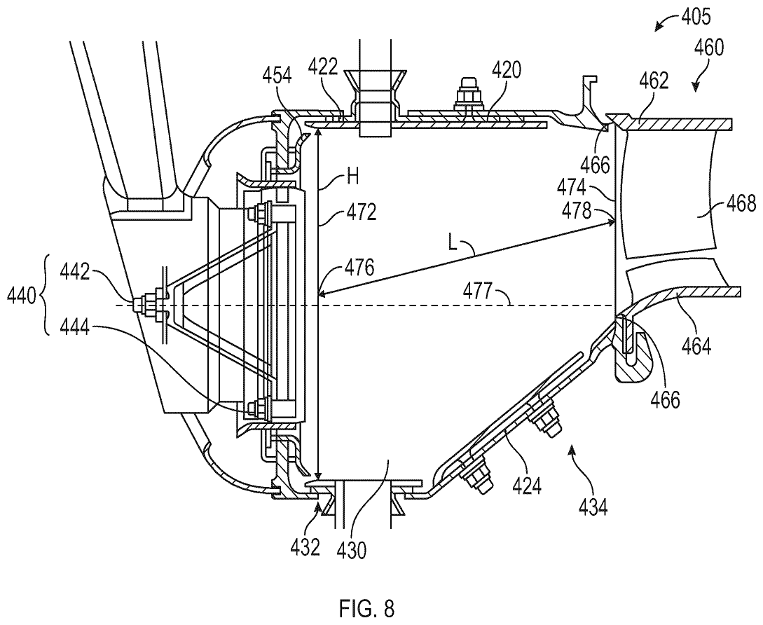

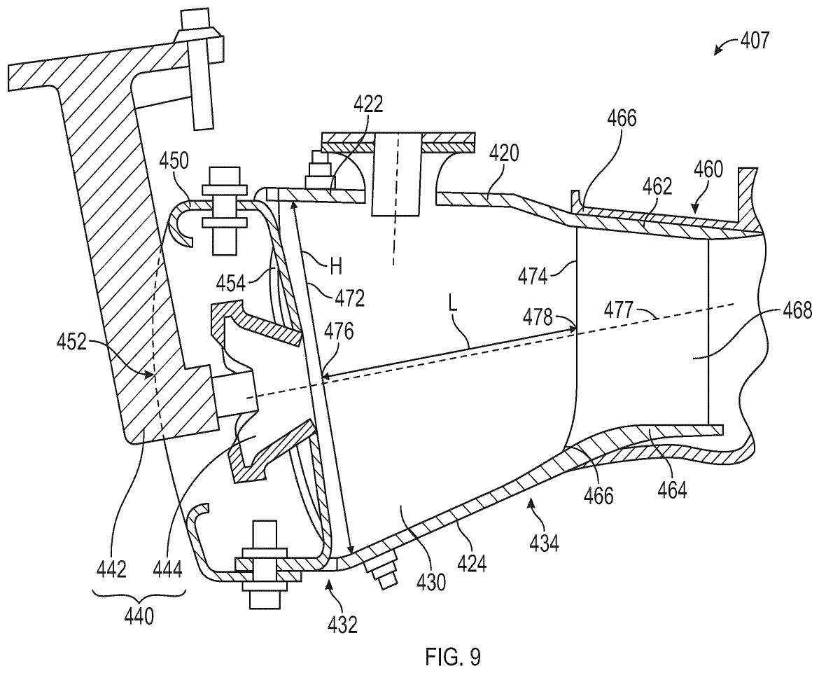

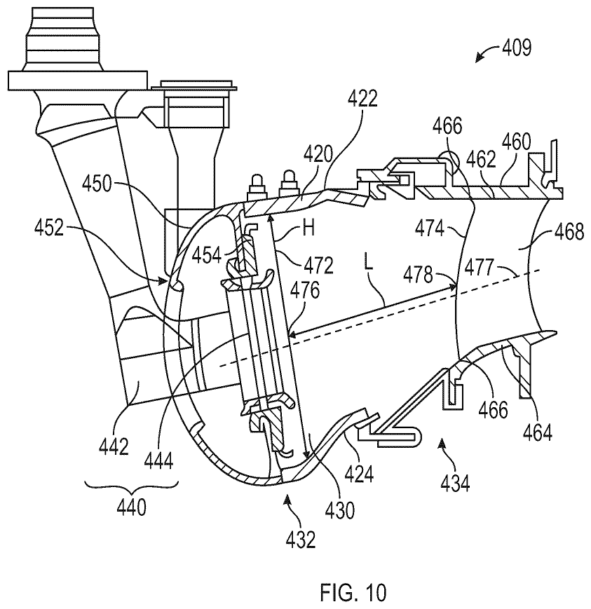

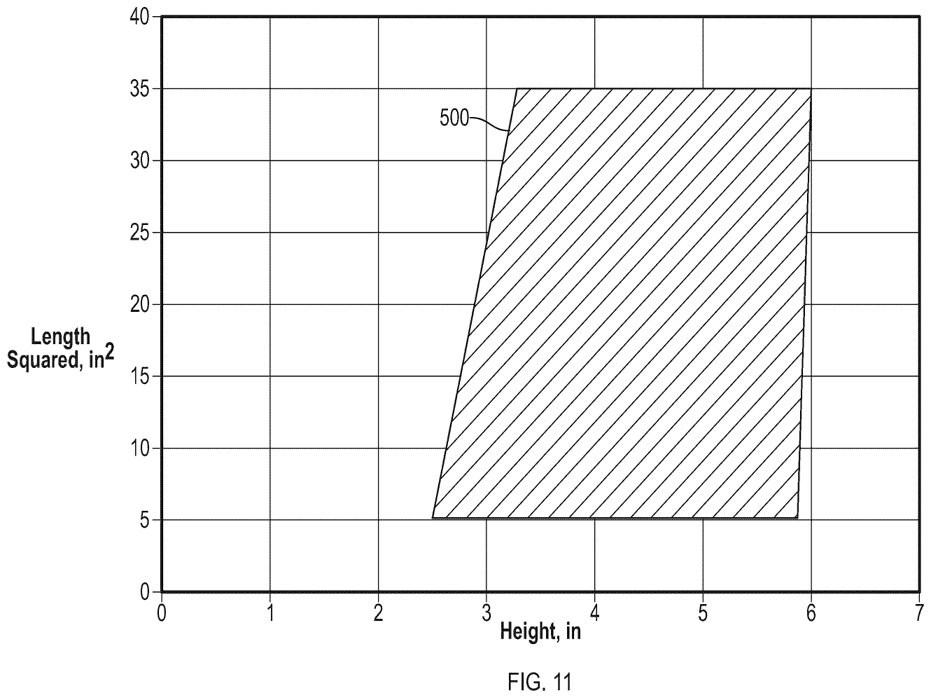

As noted above, we conceived of a wide variety of combustors having different shapes and sizes. FIGS. 6 to 10 show various combustor shapes that can suitably be used as the combustor 150 for the gas turbine engines 20 discussed herein. FIGS. 6 to 10 are a detail views showing detail 6 in FIG. 2, and, as FIG. 2 is a cross-sectional view, FIGS. 6 to 10 are also cross-sectional views. FIG. 6 shows a first combustor 401. FIG. 7 shows a second combustor 403. FIG. 8 shows a third combustor 405. FIG. 9 shows a fourth combustor 407. FIG. 10 shows a fifth combustor 409. Although the shapes of these combustors 401, 403, 405, 407, 409 differ, each of these combustors 401, 403, 405, 407, 409 has similar components, and common reference numerals are used in FIGS. 6 to 10 to for the same or similar components of these combustors 401, 403, 405, 407, 409. Accordingly, the following detailed description of the first combustor 401 also applies to the second combustor 403, the third combustor 405, the fourth combustor 407, and the fifth combustor 409. Some components, such as the combustor casing 410, for example, may not be shown in each figure, but such components may nevertheless be applicable to the combustors 403, 405, 407, 409.

As shown in FIG. 6, combustor 401 includes a combustor casing 410 and a combustor liner 420. The combustor casing 410 of this embodiment has an outer casing 412 and an inner casing 414, and the combustor liner 420 of this embodiment has an outer liner 422 and an inner liner 424. A combustion chamber 430 is formed within the combustor liner 420. More specifically, the outer liner 422 and the inner liner 424 are disposed between the outer casing 412 and the inner casing 414. The outer liner 422 and the inner liner 424 are spaced radially from each other such that the combustion chamber 430 is defined therebetween. The outer casing 412 and the outer liner 422 form an outer passage 416 therebetween, and the inner casing 414 and the inner liner 424 form an inner passage 418 therebetween. In this embodiment, the combustor 401 is a single annular combustor, but, in other embodiments, the combustor 401 may be any other combustor, including, but not limited to a double annular combustor.

The combustion chamber 430 has a forward end 432 (downstream end) and an aft end 434 (upstream end). The fuel nozzle 442 is positioned at the forward end 432 of the combustion chamber 430. The fuel nozzle 442 of this embodiment is part of a swirler/fuel nozzle assembly 440. In this embodiment, when the combustor 401 is an annular combustor 150, a plurality of fuel nozzles 442 is arranged in an annular configuration with the plurality of fuel nozzles 442 (the swirler/fuel nozzle assemblies 440) aligned in a circumferential direction of the combustor 401.

As discussed above, the compressor section, the combustor 401, and the turbine section form, at least in part, the core air flow path 121 extending from the annular inlet 108 to the jet exhaust nozzle section 120. Air entering through the annular inlet 108 is compressed by blades of a plurality of fans of the LP compressor 110 and HP compressor 112. A cowl assembly 450 is coupled to the upstream ends of outer liner 422 and the inner liner 424, respectively. An annular opening 452 formed in the cowl assembly 450 enables compressed air from the compressor section (indicated by arrow B) to enter the combustor 401. The compressed air flows through the annular opening 452 to support combustion. Another portion of the compressed air flows around the outside of the combustor liner 420 through the outer passage 416 and the inner passage 418. This air is introduced into the combustion chamber 430 through a plurality of circumferentially spaced dilution holes 426 formed in the combustor liner 420 at positions downstream of the fuel nozzle 442.

An annular dome plate 454 extends between, and is coupled to, outer liner 422 and the inner liner 424 near their upstream ends. The plurality of circumferentially spaced swirler/fuel nozzle assemblies 440 is coupled to dome plate 454. Each swirler/fuel nozzle assembly 440 receives compressed air from the annular opening 452. The swirler/fuel nozzle assembly 440 includes a swirler 444 that is used to generate turbulence in the air. The fuel nozzle 442 injects fuel into the turbulent air flow and the turbulence promotes rapid mixing of the fuel with the air. The resulting mixture of fuel and compressed air is discharged into combustion chamber 430 and combusted in the combustion chamber 430, generating combustion gases (combustion products), which accelerate as the combustion gases leave the combustion chamber 430.

A turbine nozzle 460 is disposed at the outlet of the combustion chamber 430. The turbine nozzle 460 may be a stage 1 turbine nozzle. The turbine nozzle 460 is coupled to outer liner 422 and the inner liner 424 at the downstream (aft) ends of each of the outer liner 422 and the inner liner 424. The turbine nozzle 460 of this embodiment includes an outer band 462 and an inner band 464 coupled to outer liner 422 and the inner liner 424, respectively. The turbine nozzle 460 also includes a leading edge 466, which in this embodiment is the location where the turbine nozzle 460 is coupled to outer liner 422 and the inner liner 424, and the outer band 462 and the inner band 464 each has the leading edge 466. The turbine nozzle 460 further includes a plurality of circumferentially spaced vanes 468 extending between the outer band 462 and the inner band 464. The vanes 468 extend in a generally radial direction. The vanes 468, and the turbine nozzle 460, is a static component and the vanes 468 may be cured to direct (e.g., spin or swirl) the combustion gases to turn the turbines (e.g., drive the turbine blades) of the first stage of the HP turbine 116. In this embodiment, the turbine section is a multi-stage turbine and these combustion gases will drive subsequent stages of the HP turbine 116 and the LP turbine 118. The turbine nozzle 460 may, thus, also be referred to as a stage one nozzle (SiN). As discussed above the HP turbine 116 and the LP turbine 118, among other things, drive the LP compressor 110 and HP compressor 112.

As noted above, we realized that when designing hydrogen fuel combustor to meet NOx emission targets, the combustor residence time needs to be reduced. We sized the combustor 401, and more specifically, the combustor liner 420 for various gas turbine engines and flow rates. These different embodiments are shown below in Table 1 and were developed for different bypass ratios and thrust classes of engines, characterized by the core airflow. In particular, we considered the height H, also referred to as burner dome height, of the combustion chamber 430 and the length L, also referred to as burner length, of the combustion chamber. Diluents could be used to suppress the temperature, and, thus, NOx production, in the combustion chamber 430 when hydrogen is used as the fuel. With the combustor sized as described in these embodiments, hydrogen fuel can be used without the need of diluents. In some embodiments, no diluent is added to the combustion chamber 430 and the fuel is substantially completely diatomic hydrogen without diluent. As used herein, the term “substantially completely,” as used to describe the amount of a particular element or molecule (e.g., diatomic hydrogen), refers to at least 99% by mass of the described portion of the element or molecule, such as at least 97.5%, such as at least 95%, such as at least 92.5%, such as at least 90%, such as at least 85%, or such as at least 75% by mass of the described portion of the element or molecule.

FIGS. 6 to 10 illustrate how the height H and length L may be determined for the different shapes of combustion liners 420 shown in these figures. The height H of the combustion chamber 430 is taken at the forward end 432 of the combustion chamber 430. The height H is the maximum height between an inner surface of the outer liner 422 and an inner surface of the inner liner 424 at the forward end 432 of the combustion chamber 430. The height H is measured along a line (referred to as a forward line 472, herein) that is generally orthogonal the inner surfaces of the outer liner 422 and the inner liner 424. The forward line 472 may be orthogonal to a central axis 477 of the fuel nozzle assembly 440 and/or the fuel nozzle 442. In this manner, the height H may be orthogonal to the central axis 477. In some embodiments, the height H measured using with the forward line is the maximum height of the combustion chamber 430 and may also be the maximum dome height of the combustion chamber 430.

The length L of the combustion chamber 430 is the distance between forward line 472 and the leading edge 466 of the turbine nozzle 460. As with the height H, a line (referred to as the aft line 474, herein) can be drawn from the leading edge 466 at the outer liner 422 and leading edge at the inner liner 424. Each of the forward line 472 and the aft line 474 has a midpoint (midpoint 476 and midpoint 478, respectively) that is halfway between the outer liner 422 and the inner liner 424. The length L can be measured from the midpoint 476 of the forward line 472 to the midpoint 478 of the aft line 474. The midpoint 478 may be the midspan height of the turbine nozzle 460.

When developing a gas turbine engine, the interplay between components can make it particularly difficult to select or to develop one component during engine design and prototype testing, especially, when some components are at different stages of completion. For example, one or more components may be nearly complete, yet one or more other components may be in an initial or preliminary phase such that only one (or a few) design parameters are known. It is desired to arrive at what is possible at an early stage of design, so that the down selection of candidate optimal designs, given the tradeoffs, become more possible. Heretofore, the process has sometimes been more ad hoc, selecting one design or another without knowing the impact when a concept is first taken into consideration. For example, various aspects of the fan 126 design, the HP compressor 112 design, and/or the LP compressor 110 design may not be known, but such components impact the core air flow through the core air flow path 121, and, thus, may influence the design of the combustion chamber 430.

We desire to narrow the range of configurations or combination of features that can yield favorable results given the constraints of the design, feasibility, manufacturing, certification requirements, etc., early in the design selection process to avoid wasted time and effort. During the course of the evaluation of different embodiments as set forth above, we, the inventors, discovered, unexpectedly, that there exists a relationship between the burner length and the burner dome height, which uniquely identifies a finite and readily ascertainable (in view of this disclosure) number of embodiments suitable for a particular architecture that can meet NOx emissions for hydrogen fuel and provide desired flame residence times. This relationship is referred to by the inventors as the combustor size rating (CSR) (in), and is defined according to the following relationship (1) between burner length L (in) and burner dome height H (in):

$$Combustor Size Rating ( CSR ) = {( L )}^{2} / ( H ) \qquad ( 1 )$$

As discussed further below, we have identified a range of the Combustor Size Ratings that enable a combustion chamber 430 to be designed for a gas turbine engine 20 using hydrogen fuel. This relationship is applicable over a wide range of thrust class and engine designs. Using this unique relationship, a combustor 150 design can be developed early in the design process that meets NOx emissions targets and reduces engine weight for gas turbine engines using hydrogen fuel.

Table 1 describes exemplary embodiments 1 to 24 identifying the CSR for various hydrogen fuel burning engines. The embodiments 1 to 24 may be engines with either rich burn combustors or lean burn combustors. Each of embodiments 1 to 24 burns hydrogen fuel. Embodiments 1 to 24 may represent any of the engines described with respect to FIGS. 1 to 5 and can be applied to any of the combustion chamber 430 shapes shown in FIGS. 6 to 10. In Table 1, the CSR is determined based on the relationship (1) described above. A core air flow parameter (CAFP) (kN) is defined according to the following relationship (2) between thrust (kN) and bypass ratio, both at take off.

$$Core Air Flow Parameter = \frac{Thrust}{Bypass Ratio} \qquad ( 2 )$$

The burner length is the length L identified with respect to FIGS. 6 to 10, and in the embodiments 1 to 24 is between two inches and six inches. In embodiments 1 to 24, the burner length squared may be between six square inches and thirty-five square inches. The burner dome height is the height H identified with respect to FIGS. 6 to 10, and in the embodiments 1 to 24 is between two and one half inches and six inches.

TABLE 1

| | Combustor | Core Air Flow | | |
|---|---|---|---|---|
| | Size Rating | Parameter | Thrust | Bypass |
| Embodiment | (in) | (kN) | (kN) | Ratio |
| 1 | 4.30 | 38.16 | 332.39 | 8.71 |
| 2 | 6.67 | 49.85 | 254.26 | 5.10 |
| 3 | 6.67 | 53.44 | 272.53 | 5.10 |
| 4 | 6.67 | 51.18 | 261.03 | 5.10 |
| 5 | 6.67 | 52.36 | 267.03 | 5.10 |
| 6 | 4.69 | 21.07 | 120.10 | 5.70 |
| 7 | 4.69 | 23.80 | 121.40 | 5.10 |
| 8 | 3.01 | 12.58 | 64.53 | 5.13 |
| 9 | 3.01 | 12.18 | 62.49 | 5.13 |
| 10 | 3.00 | 16.44 | 83.70 | 5.09 |
| 11 | 3.00 | 15.20 | 82.10 | 5.40 |
| 12 | 3.00 | 14.27 | 84.20 | 5.90 |
| 13 | 3.00 | 14.27 | 84.20 | 5.90 |
| 14 | 3.00 | 14.27 | 84.20 | 5.90 |
| 15 | 2.12 | 36.55 | 321.60 | 8.80 |
| 16 | 2.12 | 39.23 | 345.20 | 8.80 |
| 17 | 2.12 | 40.65 | 349.20 | 8.59 |
| 18 | 2.12 | 40.65 | 349.20 | 8.59 |
| 19 | 2.12 | 37.34 | 299.81 | 8.03 |
| 20 | 1.67 | 13.63 | 143.10 | 10.50 |
| 21 | 1.94 | 51.51 | 489.30 | 9.50 |
| 22 | 5.51 | 40.89 | 363.90 | 8.90 |
| 23 | 2.46 | 12.72 | 147.28 | 11.58 |
| 24 | 2.70 | 5.00 | 150.00 | 30.00 |

The length L may be between 2.63 inches and 5.60 inches. The length L may be between two inches and three inches. The length L may be between two and one half inches and three and one half inches. The height H may be between 2.80 inches and 5.60 inches. The height H may be between two and one half inches and six inches. The height H may be between two and one half inches and five inches. The height H may be between four inches and five inches. The burner length squared may be between 6.89 inches and 31.36 inches. The burner length squared may be between six square inches and thirty-five square inches. The burner length squared may be between six square inches and twenty square inches. The burner length squared may be between six square inches and twelve square inches. The burner length squared may be between eight square inches and twelve square inches. The burner length squared and the height may be any values such that the CSR is less than seven inches. The burner length squared and the height may be any values such that the CSR is less than six inches.

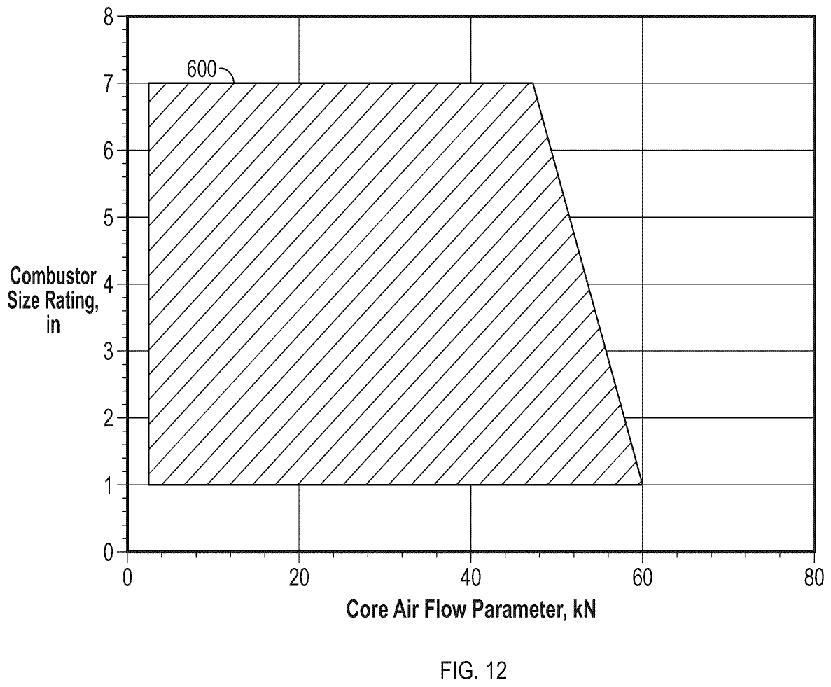

FIG. 11 represents, in graph form, the burner length, squared, as a function of the burner dome height. FIG. 11 shows that the burner length, squared, may be changed based on the burner dome height. An area 500 may present the boundaries of burner length, squared, as a function of burner dome height in which a particular combustor is designed. FIG. 12 represents, in graph form, the CSR as a function of core air flow parameter. Table 1 and FIG. 12 show that CSR may be changed based on a thrust class, as characterized by the core air flow parameter, of an engine. An area 600 may present the boundaries of CSR as a function of the core air flow parameter in which a particular combustor is designed.

As shown in FIG. 12, the CSR is less than seven inches for every core air flow. That is, the CSR is less than seven inches for every thrust class of engine. The CSR may be between 1.67 inches and 6.67 inches. The CSR may be between one inch and seven inches. The CSR may be between one and one half inches and seven inches. The CSR may be between two inches and seven inches. The CSR may be between two inches and six inches. The CSR may be between one inches and five inches. The CSR may be between two inches and five inches. The CSR may be between three inches and five inches. The core air flow parameter may be less than sixty kN. The core air flow parameter may be between five kN and 53.44 kN. The core air flow parameter may be between two and one half kN and sixty kN. The core air flow parameter may be between ten kN and twenty kN. The core air flow parameter may be between thirty kN and forty-five kN.

With continued reference to FIG. 12, the CSR may be a function of the core air flow parameter. The CSR may be based on a thrust of the gas turbine engine. The CSR may be between one inch and seven inches at a core air flow parameter between two and one half kN and sixty kN. The CSR may be between two inches and three and one quarter inches at a core air flow parameter between two and one half kN and fifty kN. The thrust may be between sixty kN and five hundred kN. The thrust may be between 62.49 kN and 489.30 kN. The CSR is defined by a relationship of the burner length, squared, and the burner dome height.

In an extension of the concepts disclosed hereinabove, also provided herein is a combustor with the dome wall having fuel cups with a dilution passage arrangement. A dilution passage arrangement is provided around each fuel cup and the dilution passage arrangement of each fuel cup can be selected to function with adjacent fuel cups and their corresponding dilution passage arrangement to collectively control the annular flame spread from all of the fuel cups as well as individually controlling the flame spread from each fuel cup. Each dilution passage arrangement includes a set of dilution passages terminating in a plurality of slots provided along the dome wall. As described herein, a single “dilution passage arrangement” refers to a plurality of slots provided around a single, corresponding fuel cup of the set of fuel cups.

It was determined that hydrogen fuel results in higher combustion temperatures as compared to combustible hydrocarbon liquid fuel and that NOx emissions are sensitive to factors including combustor residence times. The present disclosure allows for alternate flame shaping and dilution to allow for combustors that are sized to meet NOx emissions targets.

The various embodiments of the combustors, as described herein and shown in the figures, include the plurality of slots that create a layer of insulation (e.g., the curtain of compressed air) between the ignited hydrogen fuel and the dome wall, the inner liner, the outer liner, and any portions of the gas turbine engine outside of the dome wall, the inner liner and the outer liner. In these high burn temperatures it is desirable to have additional insulation between the ignited hydrogen fuel and surrounding components of the gas turbine engine.

The curtain of compressed air is further used to shape the flame within the combustion chamber, which in turn results in an enhanced control of the flame shape profile. By shaping the flame the liner wall temperature, the dome wall temperature, the combustor exit temperature profile and pattern of the flame/gas exiting the combustor is controlled. This control or shaping can further ensure that the combustion section or otherwise hot sections of the turbine engine do not fail or otherwise become ineffective by being overly heated, thus increasing the lifespan of the turbine engine. Further, the introduction of the dilution passage arrangements, as described herein, ensure an even, uniform, or otherwise desired flame propagation within the combustor.

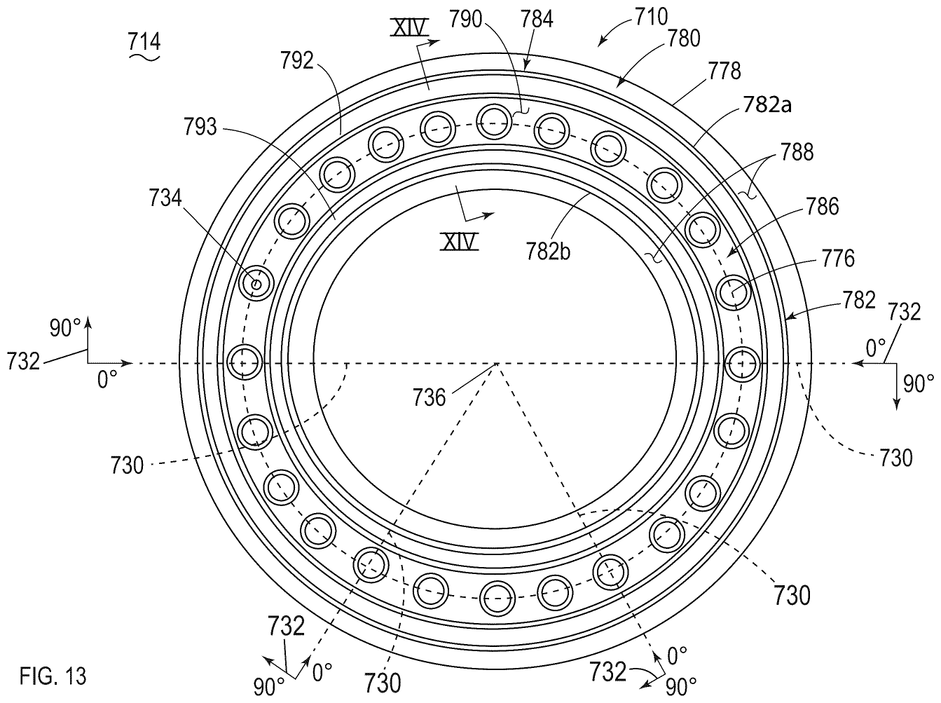

Referring now to FIG. 13 a view of a portion of a combustion section 714 of an engine can be seen. It will be understood that the combustion section 714 is similar to the combustion sections previously described and can include any features described above even if not identified further herein. A set of fuel cups 776 are disposed around a combustor centerline 736. The combustor centerline 729 can be the centerline 721 of the engine. The combustor centerline 736 can be a centerline for the combustion section 714, a single combustor, or a set of combustors that are arranged about the combustor centerline 736.

The combustor 780 can have a can, can-annular, or annular arrangement depending on the type of engine in which the combustor 780 is located. In a non-limiting example, an annular arrangement is illustrated and disposed within a casing 738. The combustor 780 is defined by a combustor liner 7872 including an outer annular combustor liner 782a and an inner annular combustor liner 782b concentric with respect to each other and annular about the combustor centerline 736. A dome assembly 784 including a dome wall 790 together with the combustor liner 782 can define a combustion chamber 786 annular about the combustor centerline 736. At least one fuel cup 736, illustrated as multiple fuel injectors annularly arranged about the combustor centerline 736, is fluidly coupled to the combustion chamber 786. A compressed air passageway 788 can be defined at least in part by both the combustor liner 782 and the casing 738.

The at least one fuel cup 736 is included within a plurality of fuel cups 736. Each fuel cup 736 can include a fuel cup centerline 734 that extends into the page. Each fuel cup centerline 734 can be arranged along a circumferential line 730. Alternatively, one or more fuel cups 736 can be offset from the circumferential line 730. Additionally, the fuel cups 736 can be arranged such that the fuel cup centerlines 734 form a pattern relative to, but not necessarily on, the circumferential line 730.

Each fuel cup centerline 734 in combination with the combustor centerline 736, can be used to define a respective fuel cup reference line 730 that extends radially from the combustor centerline 736 and through the corresponding fuel cup centerline 734. For the purposes of illustration, four fuel cup reference lines 730 are shown, however, it will be appreciated that each fuel cup 736 includes a fuel cup reference line 730. The fuel cup reference line 730 is used in this description to establish a local polar coordinate system 732 for each fuel cup 736. The local polar coordinate system defines a 0-180 degree line lying on the corresponding reference line 730, and a 90-270 degree line for each of the four illustrated fuel cup reference lines 730. The 0 degree and 90 degree lines have been shown for convenience on each of the polar coordinate systems 732. Since the fuel cups 736 are circumferentially spaced around the combustor centerline 736, a polar coordinate system based on the fuel cup reference line 730 is a convenient way to describe the local fuel cups 736, while taking into account the rotational shifts in the local coordinate system due to the circumferential arrangement.

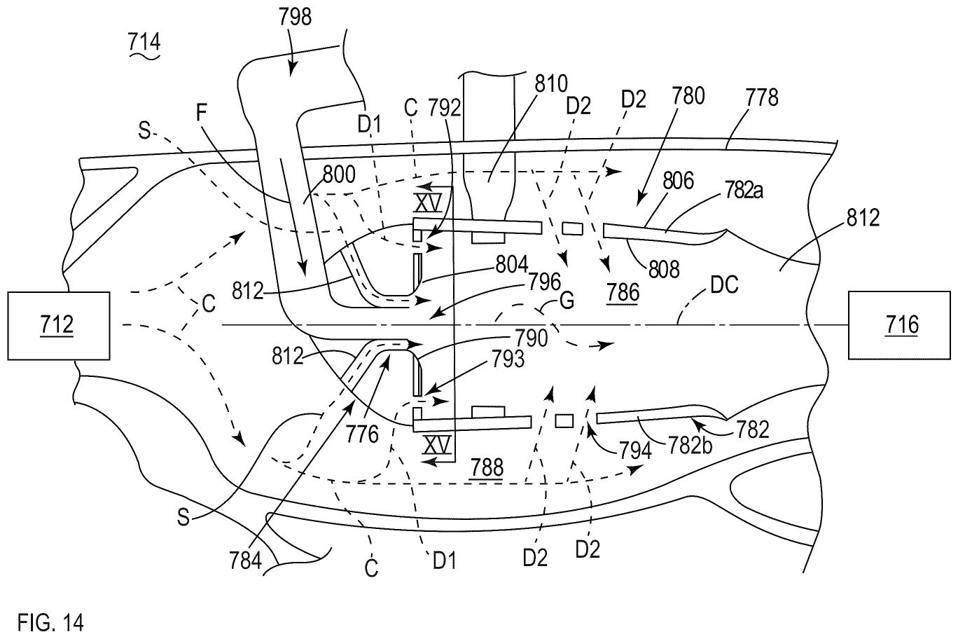

FIG. 14 illustrates first set of dilution passages 792, a second set of dilution passages 793 and a third set of dilution passages 794 can fluidly connect the compressed air passageway 788 and the combustor 780.

The fuel cup 736 can be coupled to and disposed within the dome assembly 784. The fuel cup 736 can include a flare cone 804 and a swirler 812. The flare cone 804 includes an outlet 796 of the fuel cup 736 directly fluidly coupled to the combustion chamber 786. The fuel cup 736 is fluidly coupled to a fuel inlet 798 via a linear passageway 800.

Both the inner and outer combustor liners 782a, 782b can have an outer surface 806 and an inner surface 808 at least partially defining the combustion chamber 786. The combustor liner 782 can be made of one continuous monolithic portion or be multiple monolithic portions assembled together to define the inner and outer combustor liners 782a, 782b. By way of non-limiting example, the outer surface 806 can define a first piece of the combustor liner 782 while the inner surface 808 can define a second piece of the combustor liner 782 that when assembled together form the combustor liner 782. As described herein, the combustor liner 782 includes the third set of dilution passages 794. It is further contemplated that the combustor liner 782 can be any type of combustor liner 782, including but not limited to a single wall or a double walled liner or a tile liner. An ignitor 810 can be provided at the combustor liner 782 and fluidly coupled to the combustion chamber 786, at any location, by way of non-limiting example upstream of the third set of dilution passages 794.

During operation, a compressed air (C) can flow from the compressor section 714 to the combustor 780 through the dome assembly 784. The compressed air (C) is fed to the fuel cup 736 via the swirler 812 as a swirled airflow (S). A flow of fuel (F) is fed to the fuel cup 736 via the fuel inlet 798 and the linear passageway 800. The swirled airflow (S) and the flow of fuel (F) are mixed at the flare cone 804 and fed to the combustion chamber 786 as a fuel/air mixture. The ignitor 810 can ignite the fuel/air mixture to define a flame within the combustion chamber 786, which generates a combustion gas (G). While shown as starting axially downstream of the outlet 796, it will be appreciated that the fuel/air mixture can be ignited at or near the outlet 796.

The compressed air (C) is further fed to dilution passages 792, 793 as a first dilution airflow (D1) and to the third set of dilution passages 794 as a second dilution airflow (D2). The first dilution airflow (D1) is used to direct and shape the flame, while the second dilution airflow (D2) is used to direct the combustion gas (G).

The combustor 780 shown in FIG. 14 is well suited for the use of a hydrogen-containing gas as the fuel because it helps contain the faster moving flame front associated with hydrogen fuel, as compared to traditional hydrocarbon fuels.

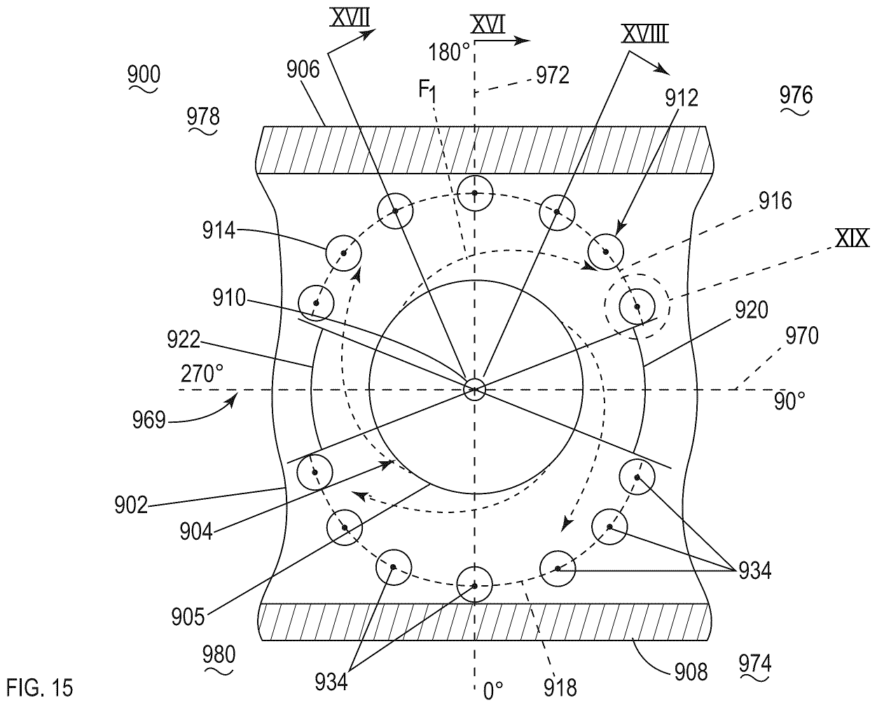

FIG. 15 is a schematic, transverse, cross-sectional view of a first dilution passage arrangement 900 on a dome wall 902 suitable for use within any of the previously described combustors. Therefore, similar parts of the first dilution passage arrangement 900 will be given similar names, with it being understood that the description applies to the first dilution passage arrangement 900, unless indicated otherwise. The first dilution passage arrangement 900 is provided on the dome wall 902 around a fuel cup 904 having a fuel cup centerline 910 and an outlet 905. The dome wall 902 extends between an outer liner 906 and an inner liner 908.

A plurality of dilution passages 912 extend through the dome wall 902 and include a plurality of slots 914. Each slot of the plurality of slots 914 defines a termination point of one or more dilution passages 912 of the plurality of dilution passages 912. Each dilution passage 912 extends along a passage centerline 934 that terminates at a respective slot 914 to define a center point (indicated by the passage centerline 934 on each dilution on each slot 914) of the respective slot 914. The plurality of slots 914 are circumferentially spaced about at least a portion of the fuel cup centerline 910. As a non-limiting example, a single dilution passage 912 terminates in a single slot 914. However, a dilution passage can have multiple branches, with each branch terminating in a slot. Each slot of the plurality of slots 914 is defined by a cross-sectional area when viewed along a vertical plane extending perpendicularly to the fuel cup centerline 910 and intersecting the slot 914. The cross-sectional area can be any suitable shape such as, but not limited to, obround, ovate, oblong, round, elongated, rectangular, triangular, or the like. Further, the cross-sectional area can be uniform or non-uniform amongst the plurality of slots 914 such that one or more of the slots can be larger or include a different shape than another slot.

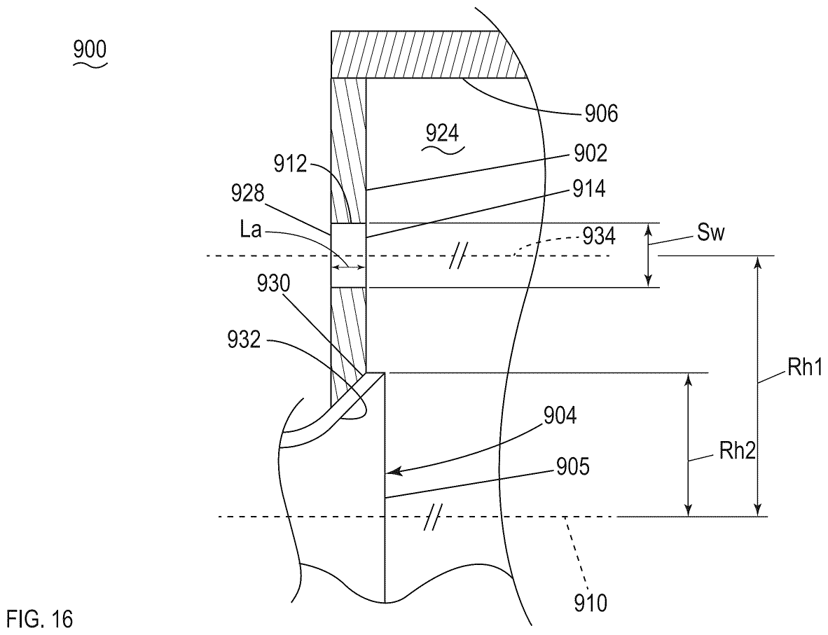

At least a portion of the plurality of slots 914 are arranged such that the passage centerline 934 is provided along a first line 916. Another portion of the plurality of slots 914 are arranged such that their passage centerlines 934 are provided along a second line 918. As illustrated, the first line 916 and the second line 918 are arcs centered on the fuel cup centerline 910. Some of these additional paths are illustrated in the different arrangements shown in FIGS. 16-27.

The first dilution passage arrangement 900 can be positioned about the fuel cup 904 with respect to a polar coordinate system 969. The polar coordinate system 969 includes a 0 degree to 180 degree line defining a fuel cup reference line 972, and a 90 degree to 270 degree line defining a transverse reference line 970. The polar coordinate system 969 can be divided into four quadrants: a first quadrant 974 between 0-90 degrees, a second quadrant 976 between 90-180 degrees, a third quadrant 978 between 180-270 degrees and a fourth quadrant 980 between 270 to 360 degrees.

The first line 916 and the second line 918 each define arc segments extending circumferentially around at least a portion of the fuel cup centerline 910. These arc segments are defined as slot-present arc segments. A first break 920 and a second break 922 are formed circumferentially between the first line 916 and the second line 918. The first break 920 and the second break 922 define opposing slot-free arc segments. The first break 920 is provided within +/−75 degrees of the transverse reference line 970. The second break 922 is provided within +/−75 degrees of the transverse reference line 970.

The first line 916 and the second line 918, and thus the plurality of slots 914, can extend across or within any suitable portion of the polar coordinate system 969. As a non-limiting example, the first line 916 or the second line 918, and thus the plurality of slots 914, can extend between at least two adjacent quadrants.

The first dilution passage arrangement 900 is symmetrical or non-symmetrical about at least one of the transverse reference line 970 or the fuel cup reference line 972.

During operation, a fuel/air mixture (F1) is supplied through the outlet 905 of the fuel cup 904. The fuel/air mixture (F1) can exit the fuel cup 904 in a straight line or otherwise include a circumferential swirl, thus defining the fuel/air mixture (F1) as a swirled fuel/air mixture. When swirled, the fuel/air mixture (F1) includes a circumferential component, with respect to the fuel cup centerline 910. The plurality of slots 914 circumscribe at least a portion of the fuel air mixture (F1).

FIGS. 16-18 illustrate various non-limiting configurations of the plurality of dilution passages 912 extending through the dome wall 902. Each dilution passage 912 extends between an inlet 928 and a respective slot 914. The passage centerline 934 extends linearly or non-linearly. The fuel cup 904 includes a flare cone 930 with a flared surface 932 opening up to the outlet 905. The dome wall 902, the outer liner 906 and the inner liner 908 (FIG. 15) at least partially define a combustion chamber 924. The outlet 905 of the fuel cup 904 and the slot 914 of the dilution passage 912 are each directly fluidly coupled to respective portions of the combustion chamber 924. It will be appreciated that the dilution passage 912 can take any suitable form and include any other suitable structure. As a non-limiting example, the inlet 928 can flare outwardly to define a funnel or otherwise include a chute that extends axially from the dome wall 902, with respect to the passage centerline 934.

FIG. 16 illustrates a partial cross-sectional side view of a dilution passage 912 of the plurality of dilution passages 912. The passage centerline 934 of the illustrated dilution passage 912 extends parallel to the fuel cup centerline 910 forming an axial dilution passage.

The passage centerline 934, specifically where the passage centerline 934 at the slot 914 (e.g., the center point of the slot 914), is provided a first radial height (Rh1) from the fuel cup centerline 910. The slot 914 is defined by a slot width (Sw). The dilution passage 912 extends from the inlet 928 to the slot 914 a total axial length (La), with respect to the fuel cup centerline 910. The outlet 905 of the fuel cup 904 extends a second radial height (Rh2) from the fuel cup centerline 910. The outlet 905, as a non-limiting example, is circular such that the second radial height (Rh2) is a radius of the outlet 905 and that two times the second radial height (Rh2) is the width of the outlet 905.

A ratio between the second radial height (Rh2) and the first radial height (Rh1) is greater than or equal to 1 and less than or equal to 3. A ratio of the slot width (Sw) to the width of the outlet 905 (e.g., two times the second radial height (Rh2)) is greater than or equal to 0.03 and less than or equal to 0.5. The slot width (Sw) can be any suitable size such as greater than or equal to 0.04 inches. A ratio between the total axial length (La) to the slot width (Sw) can be greater than or equal to 0.1 and less than or equal to 10.

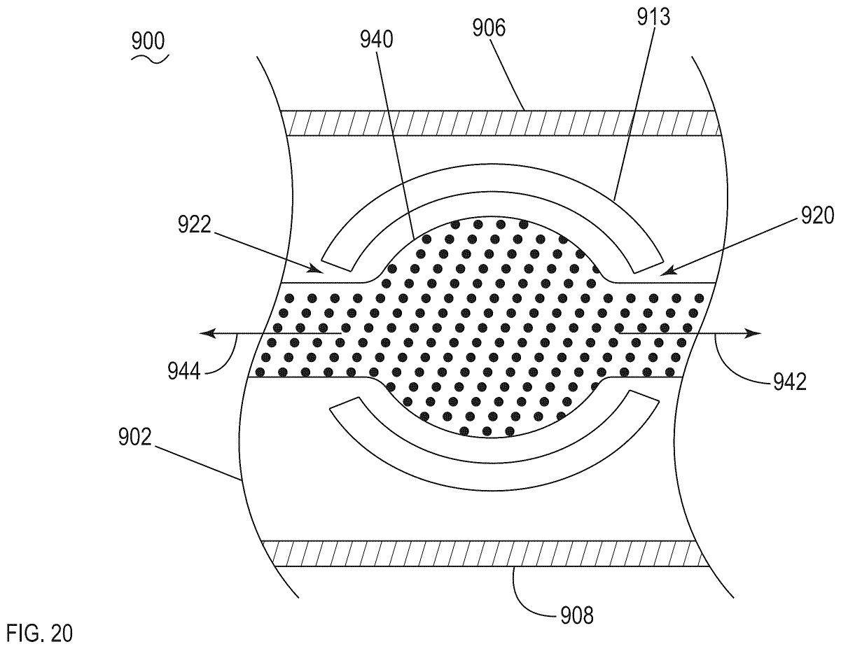

It has been found that conforming the first dilution passage arrangement 900 and the fuel cup 904 to the above-described ratios and ranges provides a distinct benefit when compared to a dilution passage arrangement 900 and fuel cup 904 that does not fall within the aforementioned ratios and ranges. These benefits will be described later in the specification with respect to FIG. 20.

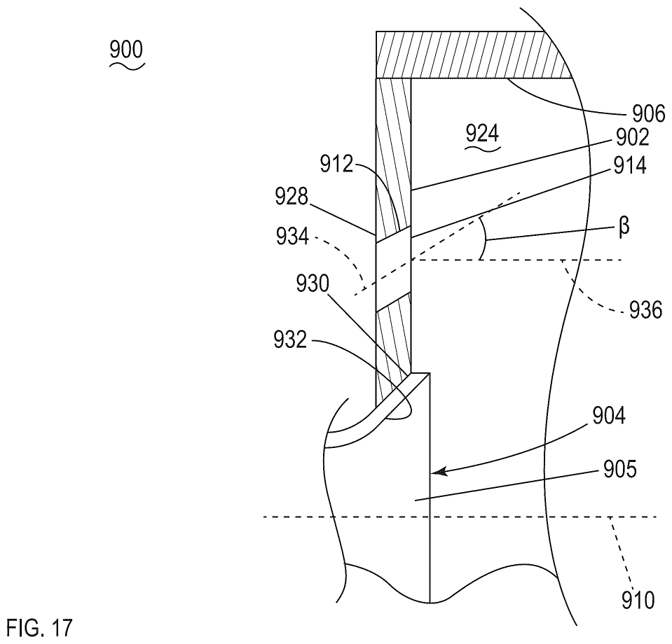

FIG. 17 illustrates a partial cross-sectional side view of a dilution passage 912 of the plurality of dilution passages 912. The passage centerline 934 of the illustrated dilution passage 912 extends radially outward from the fuel cup centerline 910 forming an outward dilution passage. The passage centerline 934 forms a first passage angle (β) with respect to a projection 936 of the fuel cup centerline 910.

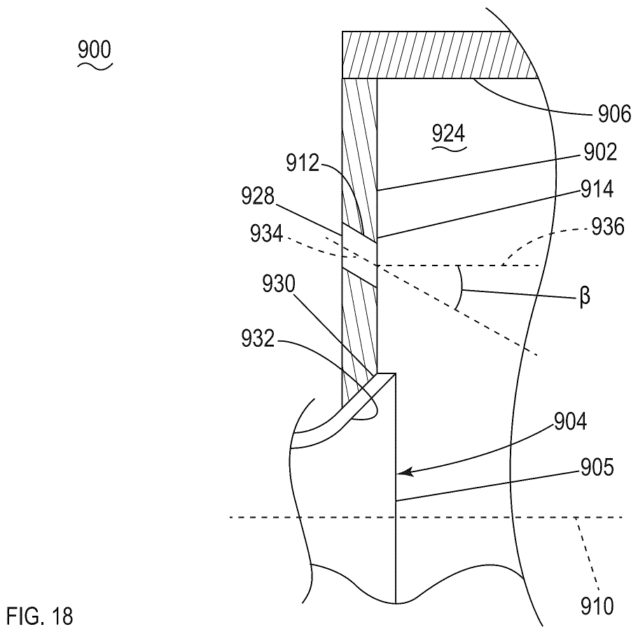

FIG. 18 illustrates a partial cross-sectional side view of a dilution passage 912 of the plurality of dilution passages 912. The passage centerline 934 of the illustrated dilution passage 912 extends radially inward towards the fuel cup centerline 910 forming an inward dilution passage. The passage centerline 934 forms a first passage angle (β) with respect to the projection 936 of the fuel cup centerline 910.

The first passage angle (β) can be any suitable angle that is greater than or equal to negative 70 degrees and less than or equal to 70 degrees.

While illustrated as the plurality of dilution passages 912 including the axial dilution passages 912, the outward dilution passages 912 and the inward dilution passages 912, it will be appreciated that the plurality of dilution passages 912 can be formed as only axial dilution passages 912, only outward dilution passages 912, only inward dilution passages 912, or any suitable combination thereof.

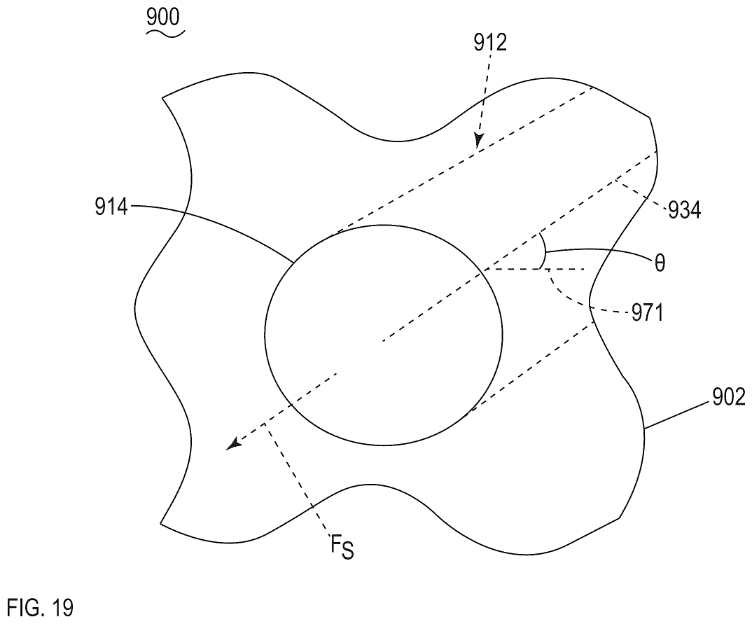

FIG. 19 is an enlarged schematic front view of the dome wall 902 as seen from section XIX of FIG. 15. As illustrated, the dilution passage 912 includes a respective passage centerline 934 that forms a second passage angle (θ) with respect to a projection 971 of the transverse reference line 970 (FIG. 15). The second passage angle (θ) can have an absolute value of greater than or equal to 0 degrees and less than or equal to 90 degrees. As a non-limiting example, the absolute value of the second passage angle (θ) of at least a portion of the dilution passages 912 can be greater than or equal to 0 degrees and less than or equal to 30 degrees. It will be further appreciated that at least a portion of the dilution passages 912 can be formed without a second passage angle (θ) such that they extend into the illustrated page and coincide with, or otherwise circumscribe, the slot 914.

A slot airflow (Fs) can flow outward from the slot 914. The slot airflow (Fs) can include the second passage angle (θ) at the slot 914. As such, the slot airflow (Fs) can be defined by a circumferential component, with respect to the fuel cup centerline 910. The circumferential component of the slot airflow (Fs) can be in line with/parallel with, or counter to/non-parallel with the circumferential component of the fuel air mixture (F1) (FIG. 15).

FIG. 20 is a schematic front view of the dome wall 902 of FIG. 15 having the same view of FIG. 15. The dilution passage arrangement 900 includes a slot-present region 913 extending between opposing breaks 920, 922. Any number of one or more slots of the plurality of slots 914 (FIG. 15) are provided within each slot-present region 913. During operation, the fuel air mixture (F1) is ignited to define a flame 940, and a compressed airflow is fed through the plurality of dilution passages 912. The compressed airflow forms a curtain around at least a portion of the circumferential extent of the flame 940. The flame 940, however, is free to flow through the first break 920 and the second break 922 in the directions indicated by arrows 942, 944, respectively.

A plurality of fuel cups 904 (FIG. 15) are circumferentially arranged about the dome wall 902. Each fuel cup 904 can include a respective first dilution passage arrangement 900. The dilution passage arrangements 900 can be the same or different between fuel cups 904. It is contemplated that the first break 920 of a first dilution passage arrangement 900 can be at least partially aligned with a second break 922 of a second dilution passage arrangement 900 that is circumferentially adjacent to the first dilution passage arrangement 900. The flame 940 that spreads through the first break 920 of the first dilution passage arrangement 900 can meet with and merge with the flame 940 that spreads through the second break 922 of the second dilution passage arrangement 900. This merging flames 940 ensures that a continuous annular ring of flame is formed along the dome wall 902, which ensures flame propagation from one fuel cup 904 to another and reduces the likelihood of a flameout at any given one of the fuel cups 904.

The flow of compressed air flowing through the slots 914 (FIG. 15) can be defined by a total slot flow. The fuel air mixture (F1) can further be defined by a total fuel cup flow. The total slot flow and the total fuel cup flow are each defined by a volume of fluid (e.g., compressed air or fuel/air mixture, respectively) that flows through the respective slots 914 or fuel cup 904 (FIG. 15) over a period of time (e.g., milliliters/second). The ratio between the total slot flow and the total fuel cup flow can be greater than or equal to 0.2 and less than or equal to 4.

The curtain of compressed air from the dilution passages 912 is used for a multitude of reasons. First, the curtain of compressed air prevents the flame 940 from contacting or otherwise overly heating the dome wall 902, the outer liner 906 and the inner liner 908. This, in turn, ensures that that dome wall 902, the outer liner 906, the inner liner 908 or any portions of the combustor or gas turbine engine outside of the dome wall 902, the inner liner 908 or the outer liner 906 are not damaged or otherwise overly heated by the flame 940. Second, the curtain of compressed air is used to shape the flame 940. The flame shaping can be done, in part, by the first passage angle (β) (FIGS. 17 and 18) or the second passage angle (θ) (FIG. 19). For example, an outward dilution passage 912 (FIG. 17) will allow the flame 940 to expand, thereby generating a flame 940 with a larger surface area, while an inward dilution passage 912 (FIG. 18) will compress or constrict the flame 940, thereby generating a flame 940 with a smaller surface area.

Further, the orientation of or the inclusion of the second passage angle (θ) can be used to provide a hydrodynamic curtain of compressed air oriented with respect to the fuel air mixture (F1). It has been found that the orientation of the curtain of compressed air can be used to shape and direct the flame 940. As a non-limiting example, when the circumferential component of the curtain of compressed air is non-parallel to the circumferential component of the fuel/air mixture (F1), the curtain of compressed air is better adapted to directing the flame 940 away from the outer liner 906 and the inner liner 908. As a non-limiting example, when the circumferential component of the curtain of compressed air is parallel to the circumferential component of the fuel air mixture (F1), the curtain of compressed air is better adapted to directing the flame 940 away from the dome wall 902. When the fuel/air mixture (F1) does not include a circumferential component, the curtain of compressed air is used to swirl the fuel/air mixture in a desired fashion.

The curtain of compressed air can further be used to ensure that the combustor including the first dilution passage arrangement 900 can use fuels with high burn temperatures, and burning at fast flame speeds, such as hydrogen-containing fuels. As hydrogen-containing fuels have a significantly higher burn temperature than traditional hydrocarbon fuels, it becomes more important to insulate the flame 940 from the dome wall 902, the outer liner 906 and the inner liner 908 and to cool the dome wall 902, the outer liner 906 and the inner liner 908. The air curtain that is generated through the first dilution passage arrangement 900 is used to provide a layer of insulation (e.g., the curtain of compressed air) between the flame 940 and the dome wall 902, the outer liner 906 and the inner liner 908 and to cool the dome wall 902, the outer liner 906 and the inner liner 908 and to direct the flame 940 away from the dome wall 902, the outer liner 906 and the inner liner 908.

It is contemplated that the ratio of Rh2:Rh1 being greater than or equal to 1 and less than or equal to 3 results in a desirable shaping of the flame 940 that does not overly heat the outer liner 906, the inner liner 908 or the dome wall 902 while still having desired properties of the flame 940. For example, if the ratio of Rh2:Rh1 were greater than 3, it has been found that the flame 940 expands radially outward, with respect to the fuel cup centerline 910 (FIG. 15), and impinges the inner liner 908 and outer liner 906, resulting in an overheating of the inner liner 908 and outer liner 906. If, however, the ratio of Rh2:Rh1 were less than 1, it has been found that the flame 940 is too centered around a central region defined by the fuel cup centerline 910, which in turn results in an undesirable profile and pattern of the flame 940.

It is contemplated that the ratio of the slot width (Sw) to the width of the outlet 905 being greater than or equal to 0.03 and less than or equal to 0.3 results in a plurality of slots 914 that have a sufficient flow rate of compressed air with respect to a flow rate of the fuel and air mixture (F1) flowing from the fuel cup 904 in order to produce a desirable shape of the flame 940. If the ratio of the of the slot width (Sw) to the width of the outlet 905 were larger than 0.3, it has been found that too much compressed air exits the plurality of slots 914, resulting in the flame 940 having too high of a velocity or otherwise being overly compressed. If, however, the ratio of the slot width (Sw) to the width of the outlet 905 is smaller than 0.03, it has been found that the compressed air exiting the plurality of slots 914 is not sufficient in creating in the curtain of compressed air that insulates the dome wall 902, the outer liner 906 and the inner liner 908 from the heat of the flame 940, nor does the curtain of compressed air have enough force to shape the flame 940 in the desired pattern.

It is contemplated that the ratio between the total axial length (La) to the slot width (Sw) being greater than or equal to 0.1 and less than or equal to 10 results in a desired velocity of the compressed air exiting the plurality of slots 914. For example, if the ratio between the total axial length (La) to the slot width (Sw) were greater than 10, the total axial length (La) is longer, meaning that the compressed air flowing through the dilution passage 912 will frictional losses, which ultimately lowers the kinetic energy, as opposed to a lower total axial length (La). This reduction in the kinetic energy due to frictional losses ultimately results in a combustor with unsatisfactory performance when compared to a combustor falling within the desired total axial length (La) to slot width (Sw) ratio. If, however, the ratio between the total axial length (La) to the slot width (Sw) were less than 0.1, it has been found that the losses (e.g., windage losses) associated with the compressed air entering the combustion chamber and merging with the fuel and air mixture (F1) within the combustion chamber. These losses ultimately results in a combustor with unsatisfactory performance when compared to a combustor falling within the desired total axial length (La) to slot width (Sw) ratio.

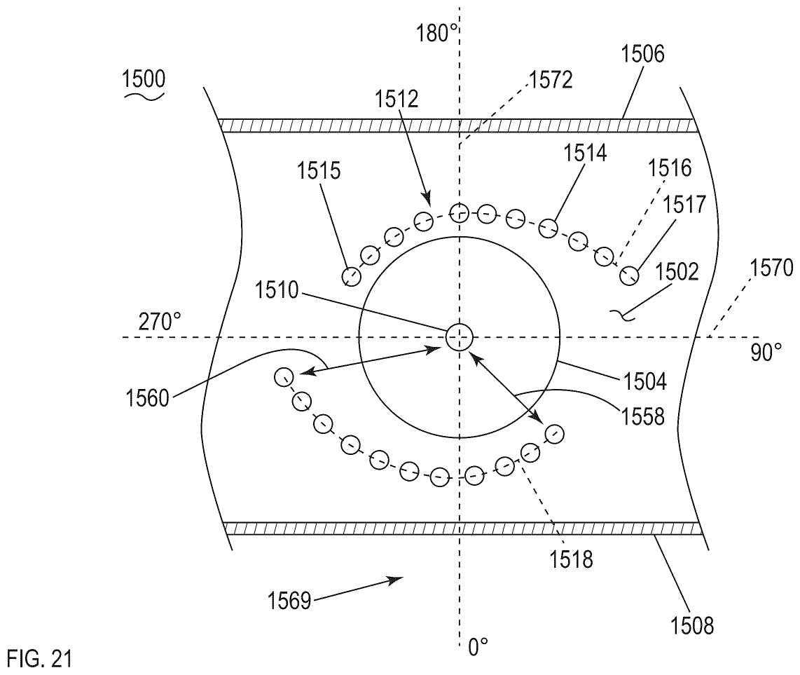

FIG. 21 is a schematic, transverse cross-sectional view of an exemplary second dilution passage arrangement 1500 suitable for use as the first dilution passage arrangement 900 of FIG. 15. The second dilution passage arrangement 1500 is similar to the first dilution passage arrangement 900, therefore, like parts will be identified by like numerals increased to the 1500 series, with it being understood that the description of the first dilution passage arrangement 900 applies to the second dilution passage arrangement 1500, unless otherwise noted.

The second dilution passage arrangement 1500 is provided on a dome wall 1502 and surrounding a fuel cup 1504 having a fuel cup centerline 1510. The dome wall 1502 extends radially between an outer liner 1506 and an inner liner 1508. A plurality of dilution passages 1512 extend through the dome wall 1502 and terminate in a plurality of slots 1514 formed along the dome wall 1502. The second dilution passage arrangement 1500 is provided along a polar coordinate system 1569 having a fuel cup reference line 1572 extending from 0 degrees to 180 degrees and a transverse reference line 1570 extending from 90 degrees to 270 degrees. The plurality of slots 1514 extend along, at least, a first line 1516 and a second line 1518.

The second dilution passage arrangement 1500 is similar to the first dilution passage arrangement 900, except that the first line 1516 and the second line 1518 each serially increase in a radial distance from the fuel cup centerline 1510 from a first slot 1515 of the plurality of slots 1514 to a second slot 1517 of the plurality of slots 1514. The first slot 1515 and the second slot 1517 can define circumferential ends of the first line 1516 or the second line 1518, such that the radial distance increases from one circumferential end (e.g., the first slot 1515 or the second slot 1517) to a second circumferential end (e.g., another of the first slot 1515 or the second slot 1517) along the respective first line 1516 or the second line 1518. The first slot 1515 and the second slot 1517 being provided on circumferentially opposite ends of the first line 1516 and the second line 1518. The first slot 1515 is a first radial distance 1558 from the fuel cup centerline 1510. The second slot 1517 is a second radial distance 1560 from the fuel cup centerline 1510. The first radial distance 1558 is smaller than the second radial distance 1560. The radial distances of the slots 1514 circumferentially between the first slot 1515 and the second slot 1517 can increase serially in a continuous or non-continuous fashion such that the first radial distance 1558 is the smallest and the second radial distance 1560 is the largest. This configuration can, for example, form a spiral pattern of slots 1514 along the dome wall 1502.

The benefit of including the spiral pattern, or serially-increasing radial heights, is that the second dilution passage arrangement 1500 can be used to further shape the flame (e.g., the flame 940 of FIG. 21) that exits the fuel cup 1504 similar to how the second passage angle (e.g., the second passage angle (θ) of FIG. 19) is used to shape the flame. For example, the first line 1516 and the second line 1518 can form a spiral that extends circumferentially (e.g., from the first slot 1515 to the second slot 1517) parallel to or counter to the circumferential direction of the fuel air mixture (e.g., the fuel air mixture (F1)) leaving the fuel cup 1504.

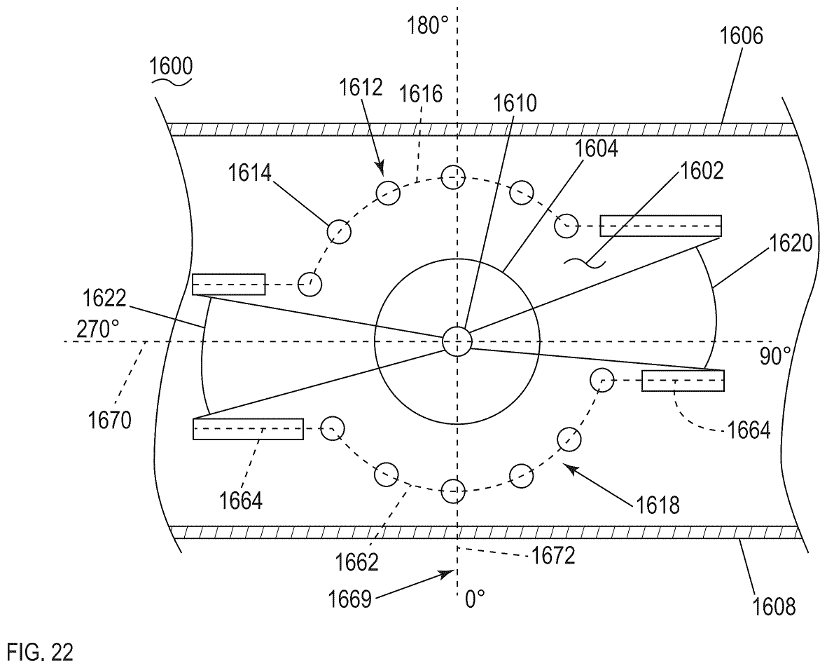

FIG. 22 is a schematic, transverse cross-sectional view of an exemplary third dilution passage arrangement 1600 suitable for use as the first dilution passage arrangement 900 of FIG. 15. The third dilution passage arrangement 400 is similar to the dilution passage arrangement 200, 1500 (FIG. 21), therefore, like parts will be identified by like numerals increased to the 1600 series, with it being understood that the description of the dilution passage arrangement 900, 1500 applies to the third dilution passage arrangement 1600, unless otherwise noted.

The third dilution passage arrangement 1600 is provided on a dome wall 1602 and surrounding a fuel cup 1604 having a fuel cup centerline 1610. The dome wall 1602 extends radially between an outer liner 1606 and an inner liner 1608. A plurality of dilution passages 1612 extend through the dome wall 1602 and terminate in a plurality of slots 1614 formed along the dome wall 1602. The third dilution passage arrangement 1600 is provided along a polar coordinate system 1669 having a fuel cup reference line 1672 extending from 0 degrees to 180 degrees and a transverse reference line 1670 extending from 90 degrees to 270 degrees. The plurality of slots 1614 extend along, at least, a first line 1616 and a second line 1618. The third dilution passage arrangement 1600 includes a first break 1620 and a second break 1622.

The third dilution passage arrangement 1600 is similar to the dilution passage arrangement 900, 1500, except that the first line 1616 and the second line 1618 each include at least two non-parallel or non-uniform portions. As a non-limiting example, the first line 1616 and the second line 1618 each include a curved line 1662 and at least one linear line 1664. The curved line 1662 can include two circumferential ends and the at least one linear line 1664 can extends outwardly from one of the two circumferential ends of the curved line 1662. As a non-limiting example, the first line 1616 and the second line 1618 each include the curved line 1662 and the at least one linear line 1664 including a first linear line extending from a first circumferential end of the curved line 1662 and a second linear line extending from a second circumferential end of the curved line 1662. The two linear lines 1664 can each be formed identical or non-identical to one another. The linear lines 1664 can extend parallel with or non-parallel to the transverse reference line 1670. There can be any number of one or more slots on the curved line 1662 and the linear lines 1664 of the first line 1616 and the second line 1618.

The linear lines 1664 can correspond to an extend along the first break 1620 and the second break 1622 and extend radially outward from, with respect to the fuel cup centerline 1610, respective portions of the corresponding curved line 1662. As such, the linear lines 1664 can form a channel for the first break 1620 and the second break 1622.

The slots 1614 provided on the first line 1616 and the second line 1618 can each be defined by a respective cross-sectional area. The cross-sectional area of the slots 1614 can be equal to or non-equal to the cross-sectional area of the slots 1614 on the second line 1618. The cross-sectional area of the slots 1614 can be constant or differ along the respective first line 1616 and the second line 1618. As a non-limiting example, the slots 1614 on the curved line 1662 can have a circular cross-sectional area while the slots 1614 on the linear lines 1664 can have an oblong cross-sectional area. The oblong cross-sectional area can be used to create elongated troughs extending along the first break 1620 and the second break 1622.

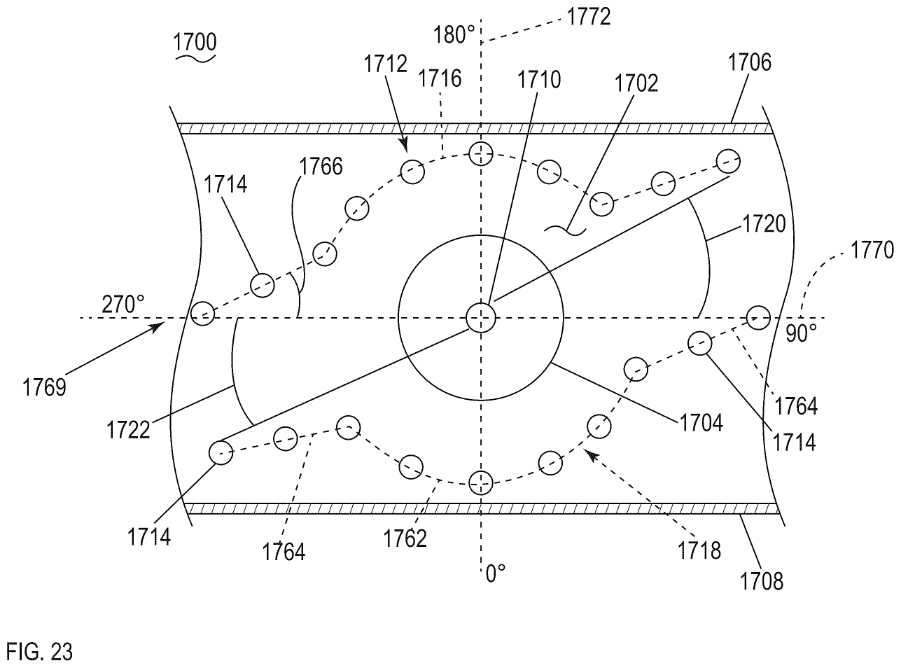

FIG. 23 is a schematic, transverse view of an exemplary fourth dilution passage arrangement 1700 suitable for use as the first dilution passage arrangement 900 of FIG. 15. The fourth dilution passage arrangement 1700 is similar to the dilution passage arrangement 900, 1500 (FIG. 21), 1600 (FIG. 22), therefore, like parts will be identified by like numerals increased to the 1700 series, with it being understood that the description of the dilution passage arrangement 900, 1500, 1600 applies to the fourth dilution passage arrangement 1700, unless otherwise noted.

The fourth dilution passage arrangement 1700 is provided on a dome wall 1702 and surrounding a fuel cup 1704 having a fuel cup centerline 1710. The dome wall 1702 extends radially between an outer liner 1706 and an inner liner 1708. A plurality of dilution passages 1712 extend through the dome wall 1702 and terminate in a plurality of slots 1714 formed along the dome wall 1702. The fourth dilution passage arrangement 1700 is provided along a polar coordinate system 1769 having a fuel cup reference line 1772 extending from 0 degrees to 180 degrees and a transverse reference line 1770 extending from 90 degrees to 270 degrees. The plurality of slots 1714 extend along, at least, a first line 1716 and a second line 1718. The fourth dilution passage arrangement 1700 includes a first break 1720 and a second break 1722.

The fourth dilution passage arrangement 1700 is similar to the third dilution passage arrangement 1600 (FIG. 22) in that it includes the first line 1716 and the second line 1718, each defined by a curved line 1762 and at least one linear line 1764 (e.g., two linear lines 1764). The difference, however, is that the at least one linear line 1764 extends at an angle 1766 with respect to the transverse reference line 1770. An absolute value of the angle 1766 can be greater than or equal to 0 degrees and less than or equal to 60 degrees.

With reference to FIGS. 22 and 23, the benefit of the dilution passage arrangements 1600, 1700 is further directing and shaping of the flame (e.g., the flame 940 of FIG. 21). For example, the channel formed by the linear lines 1664, 1764 can be used to direct or otherwise channel the flame from one dilution passage arrangement 1600, 1700 to another, circumferentially adjacent dilution passage arrangement 1600, 1700.

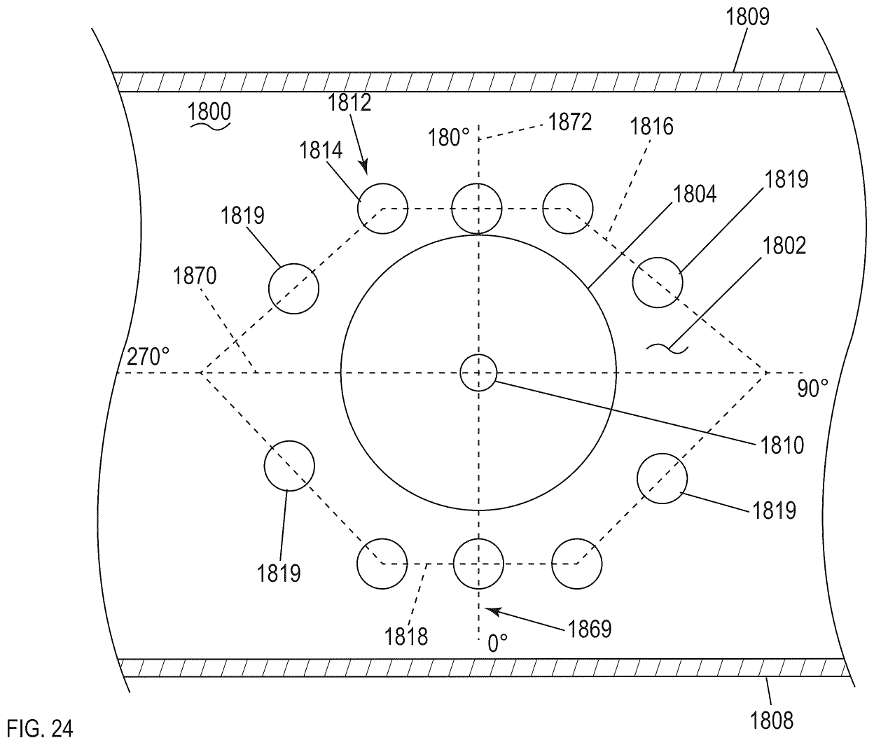

FIG. 24 is a schematic, transverse view of an exemplary fifth dilution passage arrangement 1800 suitable for use as the first dilution passage arrangement 900 of FIG. 15. The fifth dilution passage arrangement 1800 is similar to the dilution passage arrangement 900, 1500 (FIG. 21), 1600 (FIG. 22), 1700 (FIG. 23), therefore, like parts will be identified by like numerals increased to the 1800 series, with it being understood that the description of the dilution passage arrangement 900, 1500, 1600, 1700 applies to the fifth dilution passage arrangement 1800, unless otherwise noted.

The fifth dilution passage arrangement 1800 is provided on a dome wall 1802 and surrounding a fuel cup 1804 having a fuel cup centerline 1810. The dome wall 1802 extends radially between an outer liner 1806 and an inner liner 1808. A plurality of dilution passages 1812 extend through the dome wall 1802 and terminate in a plurality of slots 1814 formed along the dome wall 1802 The fifth dilution passage arrangement 1800 is provided along a polar coordinate system 1869 having a fuel cup reference line 1872 extending from 0 degrees to 180 degrees and a transverse reference line 1870 extending from 90 degrees to 270 degrees. The plurality of slots 1814 extend along, at least, a first line 1816 and a second line 1818.

For purposes of illustration, the first line 1816 and the second line 1818 are projected outwardly beyond outside slots 1819 of the plurality of slots 1814 along the first line 1816 and the second line 1818 based on a trajectory of the first line 1816 and second line 1818 at the outside slots 1819. As illustrated, the first line 1816 and the second line 1818 meet to form a continuous polygonal path about the fuel cup centerline 1810. The polygonal path can be any suitable circular or non-circular path.

The first line 1816 and the second line 1818 can meet at two location along the transverse reference line 1870. Alternatively, the first line 1816 and the second line 1818 can meet at any suitable location along the dome wall 1802.

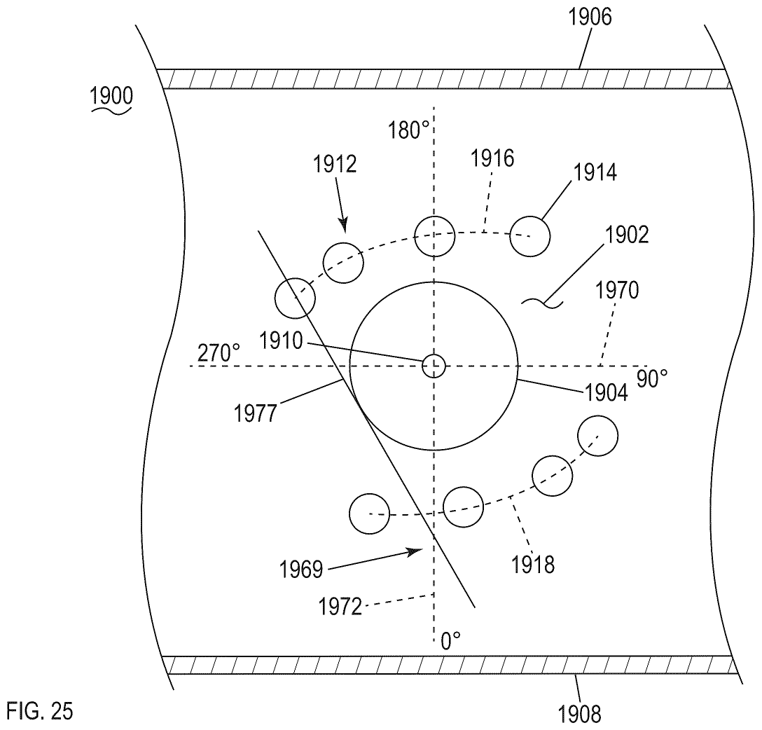

FIG. 25 is a schematic, transverse view of an exemplary sixth dilution passage arrangement 1900 suitable for use as the first dilution passage arrangement 900 of FIG. 15. The sixth dilution passage arrangement 1900 is similar to the dilution passage arrangement 900, 1500 (FIG. 21), 1600 (FIG. 22), 1700 (FIG. 23), 1800 (FIG. 24), therefore, like parts will be identified by like numerals increased to the 1900 series, with it being understood that the description of the dilution passage arrangement 900, 1500, 1600, 1700, 1800 applies to the sixth dilution passage arrangement 1900, unless otherwise noted.

The sixth dilution passage arrangement 1900 is provided on a dome wall 1902 and surrounding a fuel cup 1904 having a fuel cup centerline 1910. The dome wall 1902 extends radially between an outer liner 1906 and an inner liner 1908. A plurality of dilution passages 1912 extend through the dome wall 1902 and terminate in a plurality of slots 1914 formed along the dome wall 1902. The sixth dilution passage arrangement 1900 is provided along a polar coordinate system 1969 having a fuel cup reference line 1972 extending from 0 degrees to 180 degrees and a transverse reference line 1970 extending from 90 degrees to 270 degrees. The plurality of slots 1914 extend along, at least, a first line 1916 and a second line 1918.

The sixth dilution passage arrangement 1900 is similar to the dilution passage arrangement 900, 1500, 1600, 1700, 1800, except that the sixth dilution passage arrangement 1900 is non-symmetrical about both the transverse reference line 1970 and the fuel cup reference line 1972. The sixth dilution passage arrangement 1900 can further include a plurality of slots 1914 that are non-uniformly and non-equally distributed along the dome wall 1902. In other words, the sixth dilution passage arrangement 1900 can include any random or non-random distribution of slots 1914 along the dome wall 1902. As a non-limiting example, at least one slot 1914 can lay along a tangent line 1977 extending from the fuel cup 904.

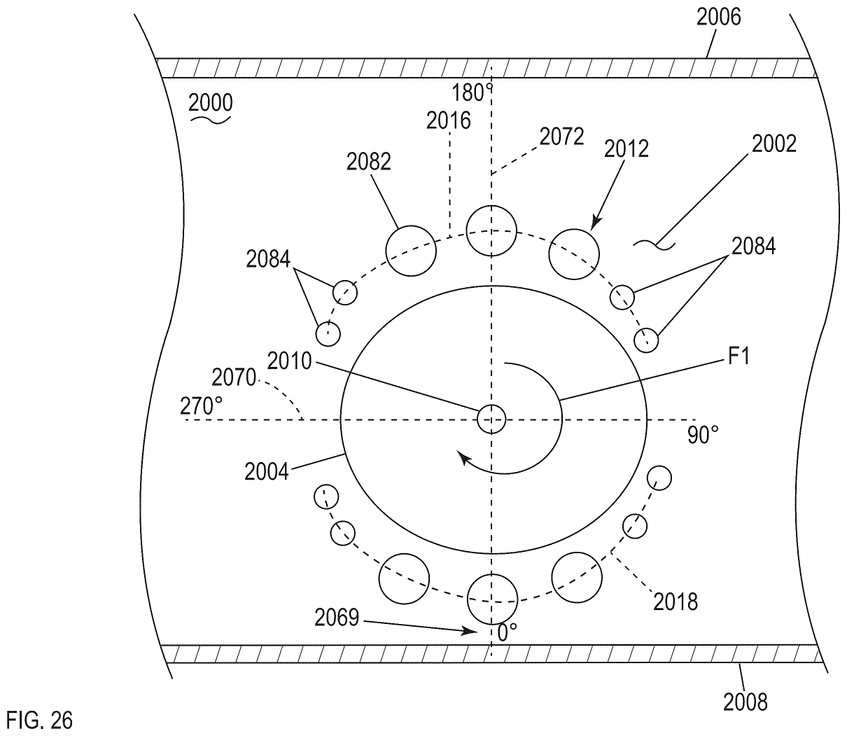

FIG. 26 is a schematic, transverse view of an exemplary seventh dilution passage arrangement 2000 suitable for use as the first dilution passage arrangement 900 of FIG. 15. The seventh dilution passage arrangement 2000 is similar to the dilution passage arrangement 900, 1500 (FIG. 10), 1600 (FIG. 11), 1700 (FIG. 12), 1800 (FIG. 13), 1900 (FIG. 14), therefore, like parts will be identified by like numerals increased to the 2000 series, with it being understood that the description of the dilution passage arrangement 900, 1500, 1600, 1700, 1800, 1900 applies to the seventh dilution passage arrangement 2000, unless otherwise noted.

The seventh dilution passage arrangement 2000 is provided on a dome wall 2002 and surrounding a fuel cup 2004 having a fuel cup centerline 2010. The dome wall 2002 extends radially between an outer liner 2006 and an inner liner 2008. A plurality of dilution passages 2012 extend through the dome wall 2002. The seventh dilution passage arrangement 2000 is provided along a polar coordinate system 2069 having a fuel cup reference line 2072 extending from 0 degrees to 180 degrees and a transverse reference line 2070 extending from 90 degrees to 270 degrees.

The set of dilution passages 2012 terminate in a first group of slots 2082 and a second group of slots 2084, each disposed on a first line 2016 and a second line 2018. The first group of slots 2082 can have a different formation with respect to the second group of slots 2084. As a non-limiting example, each slot of the first group of slots 2082 can include a cross-sectional area that is larger than or smaller than a cross-sectional area of each slot of the second group of slots 2084. As a non-limiting example, each slot of the second group of slots 2084 can include a second passage angle (e.g., the second passage angle (θ) of FIG. 20) while each slot of the first group of slots 2082 do not.

The first group of slots 2082 and the second group of slots 2084 can each be continuously provided on a suitable portion of the first line 2016 and the second line 2018. As a non-limiting example, there can be two separate groups of the second group of slots 2084 per the first line 2016 and second line 2018. As a non-limiting example, the second group of slots 2084 can be provided along circumferentially distal ends of the first line 2016 and second line 2018. It will be appreciated that the seventh dilution passage arrangement 2000 can include any number of two or more groups of slots.

The benefit of including the seventh dilution passage arrangement 2000 having the first group of slots 2082 and the second group of slots 2084 is that the seventh dilution passage arrangement 2000 allows for tuning of the flame shape and cooling/insulation efficiency of the seventh dilution passage arrangement 2000. As a non-limiting example, the second group of slots 2084 can be provided along circumferentially distal ends of the first line 2016 and the second line 2018 and include the second passage angle. The first group of slots 2082 can be provided circumferentially between the second group of slots 2084 and be inwardly, outwardly, or axial slots without a second passage angle. As such, the second group of slots 2084 can be used to provide the hydrodynamic curtain of air that is in-line with or counter to the fuel air mixture, as described herein, while the first group of slots 2082 can be used to compress or expand the flame.

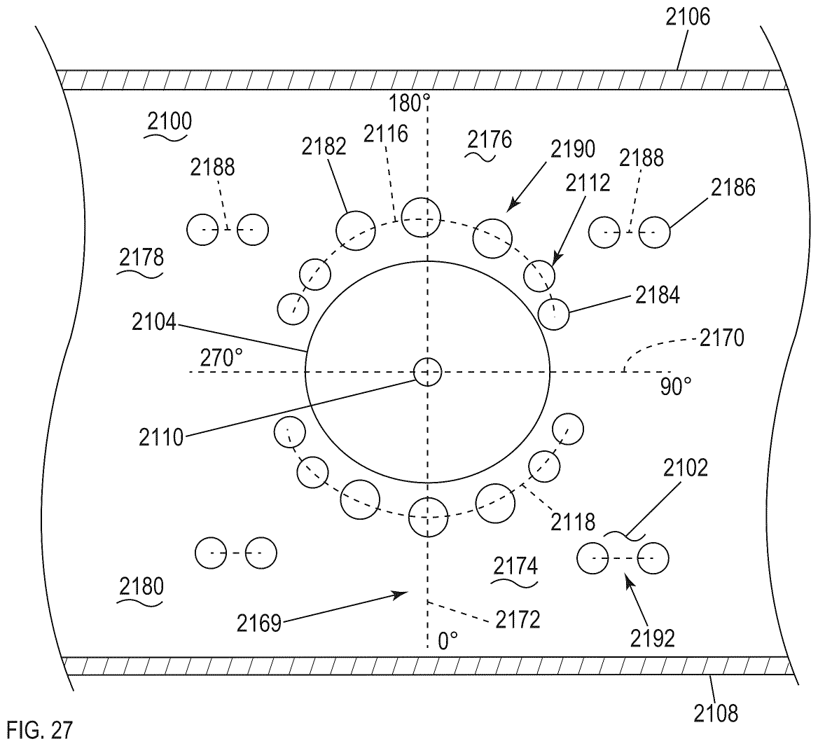

FIG. 27 is a schematic, transverse view of an exemplary eighth dilution passage arrangement 2100 suitable for use as the first dilution passage arrangement 2100 of FIG. 15. The eighth dilution passage arrangement 2100 is similar to the dilution passage arrangement 900, 1500 (FIG. 10), 1600 (FIG. 11), 1700 (FIG. 12), 1800 (FIG. 13), 1900 (FIG. 14), 2000 (FIG. 15), therefore, like parts will be identified by like numerals increased to the 2100 series, with it being understood that the description of the dilution passage arrangement 900, 1500, 1600, 1700, 1800, 1900, 2000 applies to the eighth dilution passage arrangement 2100, unless otherwise noted.

The eighth dilution passage arrangement 2100 is provided on a dome wall 2102 and surrounding a fuel cup 2104 having a fuel cup centerline 2110. The dome wall 2102 extends radially between an outer liner 2106 and an inner liner 2108. A plurality of dilution passages 2112 extend through the dome wall 2102. The eighth dilution passage arrangement 2100 is provided along a polar coordinate system 2169 having a fuel cup reference line 2172 extending from 0 degrees to 180 degrees and a transverse reference line 2170 extending from 90 degrees to 270 degrees. The polar coordinate system 2169 includes a first quadrant 2174, a second quadrant 2176, a third quadrant 2178, and a fourth quadrant 2180.

The eighth dilution passage arrangement 2100, like the seventh dilution passage arrangement 2000, can include the first group of slots 2182 and the second group of slots 2184 disposed on a first line 2116 and a second line 2118. The difference, however, is that the eighth dilution passage arrangement 2100 further includes a third group of slots 2186 provided radially outward, with respect to the fuel cup centerline 2110, from the first group of slots 2182 and the second group of slots 2184. This, in turn, forms a first row of slots 2190 having the first group of slots 2182 and the second group of slots 2184 following the first line 2116 and the second line 2118, and a second row of slots 2192 having the third group of slots 2186 and following a third line 2188.

The third group of slots 2186 can be uniform or non-uniform with the first group of slots 2182 or the second group of slots 2184. The third line 2188 can extend linearly or non-linearly and be parallel to or non-parallel to the transverse reference line 2170. The second row of slots 2192 can include a total of four third groups of slots 2186. As a non-limiting example, one third group of slots 2186 can be provided in each of the first quadrant 2174, the second quadrant 2176, the third quadrant 2178 and the fourth quadrant 2180.

The benefit of having the first row of slots 2190 and the second row of slots 2192 is to further shape the flame (e.g., the flame 940 of FIG. 15) such that the flame does not escape through the curtain of compressed air generated by the first row of slots 2190 and the second row of slots 2192 and heat the outer liner (e.g., the outer liner 906 of FIG. 15), inner liner (e.g., the inner liner 908 of FIG. 25) or dome wall 2102.

Benefits of the present disclosure include a combustor suitable for use with a hydrogen-containing fuel. As outlined previously, hydrogen-containing fuels have a higher flame temperature than traditional fuels (e.g., fuels not containing hydrogen). That is, hydrogen or a hydrogen mixed fuel typically has a wider flammable range and a faster burning velocity than traditional fuels such petroleum-based fuels, or petroleum and synthetic fuel blends. These high burn temperatures of hydrogen-containing fuel mean that additional insulation is needed between the ignited hydrogen-containing fuel and surrounding components of the gas turbine engine (e.g., the dome wall, the inner/outer liner, and other parts of the gas turbine engine). The combustor, as described herein, includes the plurality of slots that create a layer of insulation (e.g., the curtain of compressed air) between the ignited hydrogen-containing fuel and the dome wall, the inner liner, the outer liner, and any portions of the gas turbine engine outside of the dome wall, the inner liner and the outer liner. The curtain of compressed air is further used to shape the flame within the combustion chamber, which in turn results in an enhanced control of the flame shape profile. By shaping the flame the liner wall temperature, the dome wall temperature, the combustor exit temperature profile and pattern of the flame/gas exiting the combustor can be controlled. This control or shaping can further ensure that the combustion section or otherwise hot sections of the turbine engine do not fail or otherwise become ineffective by being overly heated, thus increasing the lifespan of the turbine engine. Further, the introduction of the dilution passage arrangements, as described herein, ensure an even, uniform, or otherwise desired flame propagation within the combustor.

Benefits associated with using hydrogen-containing fuel over conventional fuels include an eco-friendlier engine as the hydrogen-containing fuel, when combusted, generates less carbon pollutants than a combustor using conventional fuels. For example, a combustor including 100% hydrogen-containing fuel (e.g., the fuel is 100% H₂) would have zero carbon pollutants. The combustor, as described herein, can be used in instances where 100% hydrogen-containing fuel is used.

Further benefits associated with using hydrogen-containing fuel over conventional fuels include a gas turbine engine that can utilize less fuel due to higher heating vale of fuel to achieve same turbine inlet temperatures. For example, a conventional gas turbine engine using conventional fuels will require more fuel to produce the same amount of work or engine output as the present gas turbine engine using hydrogen-containing fuels. This, in turn, means that either less amount of fuel can be used to generate the same amount of engine output as a conventional gas turbine engine, or the same amount of fuel can be used to generate an excess of increased engine output when compared to the conventional gas turbine engine.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Further aspects of the present disclosure are provided by the subject matter of the following clauses.

A gas turbine engine includes a hydrogen fuel delivery assembly configured to deliver a hydrogen fuel flow, a compressor section configured to compress air flowing therethrough to provide a compressed air flow, and a combustor including a combustion chamber having a burner length L and a burner dome height H, the combustion chamber configured to combust a mixture of the hydrogen fuel flow and the compressed air flow, and the combustion chamber being characterized by a combustor size rating between one inch and seven inches.

The gas turbine engine of the preceding clause, wherein the combustor further includes an outer liner and an inner liner, the combustion chamber having a forward end and being defined between the outer liner and the inner liner, each of the outer liner and the inner liner having an inner surface, and wherein H is the maximum height between the inner surface of the outer liner and the inner surface of the inner liner at the forward end of the combustion chamber.

The gas turbine engine of any preceding clause, wherein the combustor size rating is between two inches and seven inches.

The gas turbine engine of any preceding clause, wherein the combustor size rating is between two inches and six inches.

The gas turbine engine of any preceding clause, wherein the combustor size rating is between three inches and six inches.

The gas turbine engine of any preceding clause, wherein the burner length is between two inches and six inches.

The gas turbine engine of any preceding clause, wherein the burner length is between two inches and three inches.

The gas turbine engine of any preceding clause, wherein the burner length is between two and one half inches and three and one half inches.

The gas turbine engine of any preceding clause, wherein the burner dome height is between two and one half inches and six inches.

The gas turbine engine of any preceding clause, wherein the burner dome height is between two and one half inches and five inches.

The gas turbine engine of any preceding clause, wherein the burner dome height is between four inches and five inches.

The gas turbine engine of any preceding clause, wherein the burner length, squared, is between six square inches and thirty-five square inches.

The gas turbine engine of any preceding clause, wherein the burner length, squared, is between six square inches and twenty square inches.

The gas turbine engine of any preceding clause, wherein the burner length, squared, is between six square inches and twelve square inches.

The gas turbine engine of any preceding clause, wherein the burner length, squared, is between eight square inches and twelve square inches.

The gas turbine engine of any preceding clause, wherein no diluent is added to the combustion chamber.

The gas turbine engine of any preceding clause, wherein the combustor size rating is defined by a relationship of the burner length, squared, and the burner dome height.

The gas turbine engine of any preceding clause, further comprising a turbine nozzle downstream of the combustion chamber, wherein L is the distance between a plane orthogonal to a forward line at which the burner dome height is measured and a leading edge of the turbine nozzle.

The gas turbine engine of any preceding clause, further comprising one or more rotating blades.

The gas turbine engine of any preceding clause, further comprising one or more stationary vanes, wherein the one or more stationary vanes are positioned forward of the rotating blades.

The gas turbine engine of any preceding clause, further comprising one or more stationary vanes, wherein the one or more stationary vanes are positioned aft of the rotating blades.

The gas turbine engine of any preceding clause, further comprising a first set of one or more rotating blades and a second set of rotating blades, the first set of rotating blades and the second set of rotating blades being configured to operate in a counter-rotating fashion.

The gas turbine engine of any preceding clause, further comprising a plurality of fan blades located forward of the combustor in a puller configuration.

The gas turbine engine of any preceding clause, further comprising a plurality of fan blades, the combustor located forward of the plurality of fan blades in a pusher configuration.

The gas turbine engine of any preceding clause, wherein the gas turbine engine is one of a turbofan engine, an unducted single fan engine, a turbojet engine, a turboshaft engine, or a turboprop engine.

The gas turbine engine of any preceding clause, wherein the gas turbine engine is a turbofan engine comprising an outer nacelle that houses the compressor section, the combustor, and a plurality of fan blades.

The gas turbine engine of any preceding clause, wherein the gas turbine engine is an unducted single fan engine comprising a spinner coupled to a nacelle, the nacelle housing the compressor section and the combustor, a plurality of outlet guide vanes coupled to an outer surface of the nacelle, and a plurality of fan blades coupled to the spinner and rotatable therewith.

The gas turbine engine of any preceding clause, wherein the gas turbine engine is a turbojet engine comprising an outer nacelle that houses the compressor section and the combustor, the turbojet engine not including a fan with bypass duct.

The gas turbine engine of any preceding clause, further including a hydrogen fuel tank for holding the hydrogen fuel in a liquid phase, the hydrogen fuel delivery assembly being connected to the hydrogen fuel tank, and a vaporizer in communication with the hydrogen fuel delivery assembly for heating the hydrogen fuel in the liquid phase to at least one of a gaseous phase and a supercritical phase, the vaporizer being located between the hydrogen fuel tank and the combustor.

An aircraft including a fuselage, a wing connected to the fuselage, and the gas turbine engine of any preceding clause.

The aircraft of the preceding clause, wherein the hydrogen fuel tank is positioned at least partially within at least one of the fuselage and the wing, and wherein the vaporizer is positioned at least partially within at least one of the fuselage, the wing, and the gas turbine engine.

A gas turbine engine including a hydrogen fuel delivery assembly configured to deliver a hydrogen fuel flow, a compressor section configured to compress air flowing therethrough to provide a compressed air flow, and a combustor including a combustion chamber characterized by a combustor size rating between one inch and seven inches at a core air flow parameter between two and one half kN and sixty kN, wherein the combustor size rating is a function of the core air flow parameter.

The gas turbine engine of any preceding clause, wherein the core air flow parameter is a relationship between the thrust and bypass ratio.

The gas turbine engine of any preceding clause, wherein the combustor size rating is between two inches and three and one quarter inches at a core air flow parameter between two and one half kN and fifty kN.

The gas turbine engine of any preceding clause, wherein the combustor size rating is based on a thrust of the gas turbine engine.

The gas turbine engine of any preceding clause, wherein the thrust is between sixty kN and five hundred kN.

The gas turbine engine of any preceding clause, wherein the combustor size rating is defined by a relationship of the burner length, squared, and the burner dome height.

The gas turbine engine of any preceding clause, further comprising a turbine nozzle downstream of the combustion chamber, wherein the burner length is the distance between a plane orthogonal to a forward line at which the burner dome height is measured and a leading edge of the turbine nozzle.

The gas turbine engine of any preceding clause, wherein the burner length, squared, is between six square inches and thirty-five square inches.

The gas turbine engine of any preceding clause, wherein the combustor further includes an outer liner and an inner liner, the combustion chamber having a forward end and being defined between the outer liner and the inner liner, each of the outer liner and the inner liner having an inner surface, and wherein the burner dome height is the maximum height between the inner surface of the outer liner and the inner surface of the inner liner at the forward end of the combustion chamber.

The gas turbine engine of any preceding clause, wherein the combustor size rating is between two inches and seven inches.

The gas turbine engine of any preceding clause, wherein the combustor size rating is between two inches and six inches.

The gas turbine engine of any preceding clause, wherein the combustor size rating is between three inches and six inches.

The gas turbine engine of any preceding clause, wherein the burner length is between two inches and six inches.

The gas turbine engine of any preceding clause, wherein the burner length is between two inches and three inches.

The gas turbine engine of any preceding clause, wherein the burner length is between two and one half inches and three and one half inches.

The gas turbine engine of any preceding clause, wherein the burner dome height is between two and one half inches and six inches.

The gas turbine engine of any preceding clause, wherein the burner dome height is between two and one half inches and five inches.

The gas turbine engine of any preceding clause, wherein the burner dome height is between four inches and five inches.

The gas turbine engine of any preceding clause, wherein the burner length, squared, is between six square inches and twenty square inches.

The gas turbine engine of any preceding clause, wherein the burner length, squared, is between six square inches and twelve square inches.

The gas turbine engine of any preceding clause, wherein the burner length, squared, is between eight square inches and twelve square inches.

The gas turbine engine of any preceding clause, wherein no diluent is added to the combustion chamber.

The gas turbine engine of any preceding clause, further comprising one or more rotating blades.

The gas turbine engine of any preceding clause, further comprising one or more stationary vanes, wherein the one or more stationary vanes are positioned forward of the rotating blades.

The gas turbine engine of any preceding clause, further comprising one or more stationary vanes, wherein the one or more stationary vanes are positioned aft of the rotating blades.

The gas turbine engine of any preceding clause, further comprising a first set of one or more rotating blades and a second set of rotating blades, the first set of rotating blades and the second set of rotating blades being configured to operate in a counter-rotating fashion.

The gas turbine engine of any preceding clause, further comprising a plurality of fan blades located forward of the combustor in a puller configuration.

The gas turbine engine of any preceding clause, further comprising a plurality of fan blades, the combustor located forward of the plurality of fan blades in a pusher configuration.

The gas turbine engine of any preceding clause, wherein the gas turbine engine is one of a turbofan engine, an unducted single fan engine, a turbojet engine, a turboshaft engine, or a turboprop engine.

The gas turbine engine of any preceding clause, wherein the gas turbine engine is a turbofan engine comprising an outer nacelle that houses the compressor section, the combustor, and a plurality of fan blades.

The gas turbine engine of any preceding clause, wherein the gas turbine engine is an unducted single fan engine comprising a spinner coupled to a nacelle, the nacelle housing the compressor section and the combustor, a plurality of outlet guide vanes coupled to an outer surface of the nacelle, and a plurality of fan blades coupled to the spinner and rotatable therewith.

The gas turbine engine of any preceding clause, wherein the gas turbine engine is a turbojet engine comprising an outer nacelle that houses the compressor section and the combustor, the turbojet engine not including a fan with bypass duct.

The gas turbine engine of any preceding clause, further including a hydrogen fuel tank for holding the hydrogen fuel in a liquid phase, the hydrogen fuel delivery assembly being connected to the hydrogen fuel tank, and a vaporizer in communication with the hydrogen fuel delivery assembly for heating the hydrogen fuel in the liquid phase to at least one of a gaseous phase and a supercritical phase, the vaporizer being located between the hydrogen fuel tank and the combustor.

An aircraft including a fuselage, a wing connected to the fuselage, and the gas turbine engine of any preceding clause.

The aircraft of the preceding clause, wherein the hydrogen fuel tank is positioned at least partially within at least one of the fuselage and the wing, and wherein the vaporizer is positioned at least partially within at least one of the fuselage, the wing, and the gas turbine engine.

A gas turbine engine includes a hydrogen fuel delivery assembly configured to deliver a hydrogen fuel flow, a compressor section configured to compress air flowing therethrough to provide a compressed air flow, and a combustor defining a combustor centerline and including a set of fuel cups circumferentially spaced relative to the combustor centerline, with each fuel cup having a fuel cup centerline, a set of dilution passages for each fuel cup of the set of fuel cups, with each dilution passage of the set of dilution passages having a passage centerline, and a plurality of slots spaced about a fuel cup in the set of fuel cups, with each slot of the plurality of slots defining a termination of at least one dilution passage of the set of dilution passages and including a center point defined as a location where the passage centerline of the at least one dilution passage intersects the slot, a combustion chamber characterized by a combustor size rating between one inch and seven inches at a core air flow parameter between two and one half kN and sixty kN, wherein the combustor size rating is a function of the core air flow parameter, and wherein the combustor size rating is defined by a relationship of the burner length, squared, and the burner dome height and wherein the core air flow parameter is a relationship between the thrust and bypass ratio.

The gas turbine engine of any preceding clause, wherein the center points of the plurality of slots are located on a polar coordinate system having a fuel cup reference line extending through the fuel cup centerline and defining a 0 degree to 180 degree reference line, with 0 degrees being radially closest to the combustor centerline, a transverse reference line defining a 90 degree to 270 degree reference line, a first quadrant extending between 0 degrees and 90 degrees, a second quadrant extending between 90 degrees and 180 degrees, a third quadrant extending between 180 degrees and 270 degrees, and a fourth quadrant extending between 270 degrees and 360 degrees, wherein opposing breaks are defined by slot-free arc segments between +/−75 degrees from the transverse reference line, and opposing slot-present arc segments are located between the slot-free arc segments, with the plurality of slots being located in the slot-present arc segments and not present in the slot-free arc segments.

The gas turbine engine of any preceding clause, wherein opposing breaks are defined by slot-free arc segments between +/−75 degrees from the transverse reference, and opposing slot-present arc segments are located between the slot-free arc segments, with the plurality of slots being located in the slot-present arc segments and not present in the slot-free arc segments.

The gas turbine engine of any preceding clause, wherein the passage centerline forms a first passage angle with respect to the fuel cup centerline, with the first passage angle being greater than or equal to −70 degrees and less than or equal to 70 degrees.

The gas turbine engine of any preceding clause, wherein the set of dilution passages includes a first dilution passage having a first passage angle and a second dilution passage having a first passage angle, non-equal to the first passage angle of the first dilution passage.

The gas turbine engine of any preceding clause, wherein each dilution passage includes a respective first passage angle that is non-equal to each of the other first passage angles.

The gas turbine engine of any preceding clause, wherein the plurality of slots includes a first row of slots provided along a first line and a second row of slots positioned radially outward from the first row of slots, and being provided along a second line, separate from the first line.

The gas turbine engine of any preceding clause, wherein the second line is linear.

The gas turbine engine of any preceding clause, wherein the second line forms a 0 degree angle with respect to the transverse reference line.

The gas turbine engine of any preceding clause, wherein the second line forms an angle with respect to the transverse reference line having an absolute value greater than 0 degrees and less than or equal to 60 degrees.

The gas turbine engine of any preceding clause, wherein the first line is non-linear.

The gas turbine engine of any preceding clause, wherein the first passage angle of the plurality of slots provided on the first line are larger than the first passage angle of the plurality of slots provided on the second line.

The gas turbine engine of any preceding clause, wherein the plurality of slots extend between at least two adjacent quadrants.

The gas turbine engine of any preceding clause, wherein the plurality of slots are provided along a first line, and each slot of the plurality of slots on the first line is provided a radial distance from the fuel cup centerline, with the radial distance serially increasing from one circumferential end of the first line to another circumferential end of the first line.

The gas turbine engine of any preceding clause, wherein a first subset of the plurality of slots follow a curved line, and a second subset of the slots follow a linear line extending from a circumferential end of the curved line, with the linear line corresponding to at least one of the opposing breaks.

The gas turbine engine of any preceding clause, wherein the linear line forms an angle with respect to the transverse reference line, the angle having an absolute value of greater than or equal to 0 degrees and less than or equal to 70 degrees.

The gas turbine engine of any preceding clause, wherein the plurality of slots are non-symmetrical about the corresponding fuel cup reference line.

The gas turbine engine of any preceding clause, wherein the plurality of slots follow a first line and a second line, separate from the first line, with the first line and the second line being symmetrical or non-symmetrical about at least one of either the fuel cup reference line or the transverse reference line.

The gas turbine engine of any preceding clause, wherein the set of dilution passages form a dilution passage arrangement about each fuel cup of the set of fuel cups, with at least two dilution passage arrangements being different from each other.

The gas turbine engine of any preceding clause, wherein the plurality of slots follow a non-circular polygonal path that extends circumferentially about the fuel cup centerline.

The gas turbine engine of any preceding clause, wherein the set of fuel cups receive a flow of fuel including a hydrogen-containing fuel.

The gas turbine engine of any preceding clause, wherein the center point of each slot of the plurality of slots is located a first radial height from the fuel cup centerline, each fuel cup of the set of fuel cups includes an outlet formed along the dome wall, with a radially outer surface of the outlet located a second radial height from the fuel cup centerline, and a ratio between the first radial height and the second radial height is greater than 1 and less than or equal to 3.

The gas turbine engine of any preceding clause, wherein each slot of the plurality of slots includes a slot width when viewed along a vertical plane perpendicular to the corresponding fuel cup centerline and intersecting a respective slot, each fuel cup of the set of fuel cups includes an outlet formed along the dome wall, the outlet having an outlet width, and a ratio between the slot width and the outlet width is greater than or equal to 0.03 and less than or equal to 0.5.

The gas turbine engine of any preceding clause, wherein a fuel/air mixture is fed to the combustion chamber, through the set of fuel cups, with a portion of the fuel/air mixture being fed through a corresponding fuel cup of the set of fuel cups at a fuel/air volumetric flow rate, and a compressed air is fed to the combustion chamber through the corresponding set of dilution passages at a compressed air volumetric flow rate, with a ratio between the fuel/air volumetric flow rate and the compressed air volumetric flow rate being greater than or equal to 0.2 and less than or equal to 4.

The gas turbine engine of any preceding clause, wherein each dilution passage of the plurality of dilution passages includes a total axial length between an inlet of the dilution passage and a respective slot, the respective slot includes a slot width when viewed along a vertical plane perpendicular to the corresponding fuel cup centerline and intersecting the respective slot, and with a ratio between the total axial length and the slot width being greater than or equal to 0.1 and less than or equal to 10.

Although the foregoing description is directed to the preferred embodiments, it is noted that other variations and modifications will be apparent to those skilled in the art and may be made without departing from the spirit or scope of the disclosure Moreover, features described in connection with one embodiment may be used in conjunction with other embodiments, even if not explicitly stated above.

1. A gas turbine engine comprising:
a hydrogen fuel delivery assembly configured to deliver a hydrogen fuel flow;
a compressor section configured to compress air flowing therethrough to provide a compressed air flow; and
a combustor configured to operate without diluent, the combustor defining a combustor centerline and comprising:
an inner liner;
an outer liner;
a set of fuel cups circumferentially spaced relative to the combustor centerline, with each fuel cup having a fuel cup centerline;
a set of dilution passages for each fuel cup of the set of fuel cups, with each dilution passage of the set of dilution passages having a passage centerline;
a plurality of slots spaced about a fuel cup in the set of fuel cups, with each slot of the plurality of slots defining a termination of at least one dilution passage of the set of dilution passages and including a center point defined as a location where the passage centerline of the at least one dilution passage intersects the slot; and
a combustion chamber characterized by a combustor size rating between one inch and seven inches at a core air flow parameter between two and one half kN and sixty kN,
wherein the combustor size rating is a function of the core air flow parameter, and
wherein the combustor size rating is defined by:
L²/H
wherein H is a maximum height of the combustion chamber measured by a forward line extending from an inner surface of the outer liner to an inner surface of the inner liner and L is a length of the combustion chamber measured from a midpoint of the forward line to a midpoint of an aft line, the aft line extending from the inner surface of the inner liner to the inner surface of the outer liner at a leading edge of a turbine nozzle,
and, wherein the core air flow parameter is defined by:
Thrust/Bypass Ratio.

2. The gas turbine engine of claim 1, wherein the combustor size rating is between two inches and three and one quarter inches at a core air flow parameter between two and one half kN and fifty kN.

3. The gas turbine engine of claim 1, wherein the combustor size rating is based on a thrust of the gas turbine engine.

4. The gas turbine engine of claim 3, wherein the thrust is between sixty kN and five hundred kN.

5. The gas turbine engine of claim 1, further comprising a turbine nozzle downstream of the combustion chamber, wherein the burner length is the distance between a plane orthogonal to a forward line at which the burner dome height is measured and a leading edge of the turbine nozzle.

6. The gas turbine engine of claim 5, wherein the burner length, squared, is between six square inches and thirty-five square inches.

7. The gas turbine engine of claim 1, wherein the center points of the plurality of slots are located on a polar coordinate system having:
a fuel cup reference line extending through the fuel cup centerline and defining a 0 degree to 180 degree reference line, with 0 degrees being radially closest to the combustor centerline;
a transverse reference line defining a 90 degree to 270 degree reference line;
a first quadrant extending between 0 degrees and 90 degrees;
a second quadrant extending between 90 degrees and 180 degrees;
a third quadrant extending between 180 degrees and 270 degrees; and
a fourth quadrant extending between 270 degrees and 360 degrees;
wherein opposing breaks are defined by slot-free arc segments between +/−75 degrees from the transverse reference line, and opposing slot-present arc segments are located between the slot-free arc segments, with the plurality of slots being located in the slot-present arc segments and not present in the slot-free arc segments.

8. The gas turbine engine of claim 7, wherein the passage centerline forms a first passage angle with respect to the fuel cup centerline, with the first passage angle being greater than or equal to −70 degrees and less than or equal to 70 degrees.

9. The gas turbine engine of claim 1, wherein the set of dilution passages includes a first dilution passage having a first passage angle and a second dilution passage having a first passage angle, non-equal to the first passage angle of the first dilution passage.

10. The gas turbine engine of claim 1, wherein each dilution passage includes a respective first passage angle that is non-equal to each of the other first passage angles.

11. The gas turbine engine of claim 1, wherein the plurality of slots includes a first row of slots provided along a first line and a second row of slots positioned radially outward from the first row of slots, and being provided along a second line, separate from the first line.

12. The gas turbine engine of claim 11, wherein a first passage angle of the plurality of slots provided on the first line are larger than a first passage angle of the plurality of slots provided on the second line.

13. The gas turbine engine of claim 1, wherein the plurality of slots are provided along a first line, and each slot of the plurality of slots on the first line is provided a radial distance from the fuel cup centerline, with the radial distance serially increasing from one circumferential end of the first line to another circumferential end of the first line.

14. The gas turbine engine of claim 1, wherein a first subset of the plurality of slots follow a curved line, and a second subset of the slots follow a linear line extending from a circumferential end of the curved line, with the linear line corresponding to at least one of the opposing breaks.

15. The gas turbine engine of claim 1, wherein the plurality of slots are non-symmetrical about a corresponding fuel cup reference line.

16. The gas turbine engine of claim 1, wherein the set of fuel cups are provided on a burner dome.

17. The gas turbine engine of claim 1, wherein the plurality of slots follow a first line and a second line, separate from the first line, with the first line and the second line being symmetrical or non-symmetrical about at least one of either a fuel cup reference line or a transverse reference line.

18. The gas turbine engine of claim 1, wherein the set of dilution passages form a dilution passage arrangement about each fuel cup of the set of fuel cups, with at least two dilution passage arrangements being different from each other.

19. The gas turbine engine of claim 1, wherein the plurality of slots follow a non-circular polygonal path that extends circumferentially about the fuel cup centerline.

20. The gas turbine engine of claim 1, wherein the set of fuel cups receive a flow of fuel including a hydrogen-containing fuel.
